(19) United States
(12) Patent Application Publication
(10) Pub. No.: US 2023/0274209 A1
(43) Pub. Date: Aug. 31, 2023

(54) FACILITY EVALUATION APPARATUS AND FACILITY EVALUATION METHOD

(71) Applicant: Mitsubishi Electric Corporation, Tokyo (JP)

(72) Inventors: Tsutomu MATSUBARA, Tokyo (JP); Masato HIRAI, Tokyo (JP); Hitoshi YOSHIZAWA, Tokyo (JP); Misato MIURA, Tokyo (JP)

(73) Assignee: Mitsubishi Electric Corporation, Tokyo (JP)

(21) Appl. No.: 18/195,393

(22) Filed: May 10, 2023

Related U.S. Application Data
(63) Continuation of application No. PCT/JP2020/046485, filed on Dec. 14, 2020.

(51) Int. Cl. G06Q 10/0631

(52) U.S. Cl. CPC G06Q 10/06313

(57) ABSTRACT

A facility evaluation apparatus is configured to include: a device information acquiring unit to acquire installed device information indicating a type of an IoT device installed in a facility to be evaluated; and an evaluation value calculating unit to calculate an evaluation value indicating a value of the facility on the basis of the installed device information acquired by the device information acquiring unit.

### CROSS-REFERENCE TO RELATED APPLICATION

The present application is a bypass-continuation of International Patent Application No. PCT/JP2020/046485, filed Dec. 14, 2020, the entire contents of which are incorporated herein by reference.

### TECHNICAL FIELD

The present disclosure relates to a facility evaluation apparatus and a facility evaluation method.

### BACKGROUND ART

In general, a user who wishes to move into a facility for the elderly or the like visits a facility that is a candidate for moving in, evaluates the facility on the basis of the appearance, atmosphere, or the like of the facility, and determines whether or not to move in to the facility. Since it is assumed that a user stays in a facility such as an elderly facility for a long period of time of at least several days to several years, it is important for the user to properly evaluate the facility before moving into such a facility. Furthermore, it is also important for the family of the user or the facility manager.

As a technique for evaluating a specific space, Patent Literature 1 discloses an information processing system that observes a change in user's emotion when the user enters or leaves the specific space, and calculates an evaluation value for the specific space on the basis of the change in the user's emotion.

### CITATION LIST

### Patent Literature

Patent Literature 1: International Publication No. 2017/022306

### SUMMARY OF INVENTION

### Technical Problem

The evaluation of a facility based on the appearance or the like of the facility is a subjective evaluation of a user. In particular, regarding a facility on which a long stay is premised, such as a facility for the elderly (hereinafter, such a facility is simply referred to as a “stay facility”), if an objective evaluation that does not depend on the subjectivity of a user is provided in addition to such a subjective evaluation of the user, it is considered to be useful for the user and the like. However, conventionally, there is a problem that a technique capable of objectively evaluating a stay facility is not provided.

The information processing system disclosed in Patent Literature 1 provides a technique for evaluating a specific space, but the evaluation value calculated by the information processing system is merely a numerical value of a temporary emotion of a user. Therefore, the information processing system cannot properly evaluate a stay facility.

The present disclosure has been made to solve the above problems, and an object thereof is to obtain a facility evaluation apparatus and a facility evaluation method capable of objectively evaluating a value of a facility.

### Solution to Problem

A facility evaluation apparatus according to the present disclosure includes processing circuitry to acquire installed device information indicating a type of an IoT device installed in a facility to be evaluated, and to set a score corresponding to an importance level of the IoT device on a basis of the type indicated by the installed device information, and calculate an evaluation value indicating a value of the facility.

### Advantageous Effects of Invention

According to the present disclosure, it is possible to objectively evaluate a value of a facility.

### BRIEF DESCRIPTION OF DRAWINGS

FIG. 1 is a configuration diagram illustrating a facility evaluation system including a facility evaluation apparatus 6 according to a first embodiment.

FIG. 2 is a configuration diagram illustrating the facility evaluation apparatus 6 according to the first embodiment.

FIG. 3 is a hardware configuration diagram illustrating hardware of the facility evaluation apparatus 6 according to the first embodiment.

FIG. 4 is a hardware configuration diagram of a computer in a case where the facility evaluation apparatus 6 is implemented by software, firmware, or the like.

FIG. 5 is a flowchart illustrating a facility evaluation method which is a processing procedure performed by the facility evaluation apparatus 6 illustrated in FIG. 2.

FIG. 6 is a configuration diagram illustrating a facility evaluation system including a facility evaluation apparatus 6 according to a second embodiment.

FIG. 7 is a configuration diagram illustrating the facility evaluation apparatus 6 according to the second embodiment.

FIG. 8 is a hardware configuration diagram illustrating hardware of the facility evaluation apparatus 6 according to the second embodiment.

FIG. 9 is an explanatory diagram illustrating an example of nursing care content.

FIG. 10 is a configuration diagram illustrating a facility evaluation apparatus 6 according to a third embodiment.

FIG. 11 is a hardware configuration diagram illustrating hardware of the facility evaluation apparatus 6 according to the third embodiment.

FIG. 12 is an explanatory diagram illustrating an example of skeleton data output from a skeleton analysis unit 41.

### DESCRIPTION OF EMBODIMENTS

In order to explain the present disclosure in more detail, a mode for carrying out the present disclosure will be described below with reference to the accompanying drawings.

First Embodiment

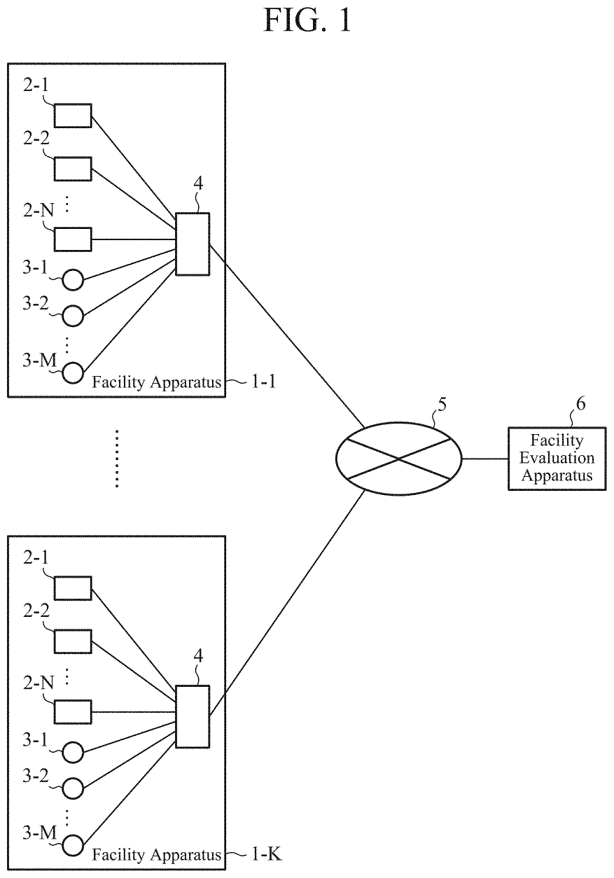

FIG. 1 is a configuration diagram illustrating a facility evaluation system including a facility evaluation apparatus 6 according to a first embodiment.

The facility evaluation system illustrated in FIG. 1 is a system in which a facility apparatus 1-k (k=1, . . . , K) installed in a facility to be evaluated is connected to a facility evaluation apparatus 6 via a network 5. The facility to be evaluated is a facility in which a user stays for a long period of time of at least several days to several years. The facilities to be evaluated include facilities of hospitals, facilities of student dormitories, and the like in addition to facilities for the elderly. Furthermore, the facilities to be evaluated include, for example, home facilities for the purpose of nursing care or medical treatment.

In the facility evaluation system illustrated in FIG. 1, K is an integer of 2 or more, but K can be 1.

The facility apparatus 1-k is installed in any one of the K facilities. The facility apparatus 1-k includes one or more Internet of Things (IoT) devices 2-n, one or more sensors 3-m, and a line concentrator 4. Each of n and m is an integer of 1 or more, and n=1, . . . , N, and m=1, . . . , M. Each of N and M is different for each facility.

That is, the number of IoT devices 2-n included in the facility apparatus 1-k is different for each facility. Furthermore, the types of the IoT devices 2-n included in the facility apparatus 1-k are different for each facility. However, this is merely an example, and the K facilities may include a plurality of facilities in which at least one of the number of IoT devices 2-n or the type of the IoT devices 2-n is the same.

The number of sensors 3-m included in the facility apparatus 1-k is different for each facility. In addition, the types of the sensors 3-m included in the facility apparatus 1-k are different for each facility. However, this is merely an example, and the K facilities may include a plurality of facilities in which at least one of the number of sensors 3-m or the type of the sensor 3-m is the same.

The IoT devices 2-n (n=1, . . . , N) are installed in each facility.

The IoT device 2-n is connected to the line concentrator 4 via a local area network (LAN), for example, and can transmit and receive information and the like to and from the facility evaluation apparatus 6 and the like.

The IoT device 2-n corresponds to, for example, a home appliance. Specifically, an air-conditioning ventilation instrument, a cooking instrument, a cleaning instrument, a bathroom undressing instrument, a lighting instrument, an audio visual (AV) instrument, a photographing instrument, or the like corresponds to the IoT device 2-n.

The air-conditioning ventilation instrument includes an air conditioner, an air cleaner, a ventilation fan, and the like, and the cooking instrument includes an induction heating (IH) cooker, a rice cooker, and the like.

The cleaning instrument includes a cleaner, a floor wiping robot, and the like, and the bathroom undressing instrument includes a bathroom water heater, a bathroom heater, a bathroom dryer, and the like.

The AV instrument includes a television, an audio device, and the like, and the photographing instrument includes a digital camera, a video camera, and the like.

The lighting instrument includes a lighting instrument that outputs light having wavelengths equivalent to wavelengths of sunlight, a lighting instrument that changes a color, brightness, or the like of light in accordance with sound output from an AV instrument, and the like.

For example, each IoT device 2-n outputs installed device information indicating each of a type and a function of the IoT device 2-n itself to the facility evaluation apparatus 6 via the line concentrator 4 and the network 5. The installed device information indicating a type of the device itself indicates that the device is an air conditioner when the IoT device 2-n is, for example, an air conditioner, indicates that the device is a television when the IoT device 2-n is, for example, a television, and indicates that the device is an air cleaner when the IoT device 2-n is, for example, an air cleaner.

If the IoT device 2-n is, for example, an air conditioner, the installed device information indicating its own function indicates the functions of the air conditioner, that is, a cooling function, a heating function, a dehumidifying function, a sterilization function, a remote operation receiving function, and the like. In a case where the IoT device 2-n is, for example, a television, the installed device information indicates functions of the television, that is, a television viewing function, a web browsing function, a recording function, a remote operation receiving function, and the like. The remote operation receiving function is a function of receiving selection of various functions, operation of various functions, or the like via the network 5 from a smartphone or the like (not illustrated) possessed by an employee or the like of the facility.

Each IoT device 2-n outputs log data indicating operation history to the facility evaluation apparatus 6 via the line concentrator 4 and the network 5. When the IoT device 2-n is, for example, an air conditioner, the log data includes an operation history regarding operation or stop of the air conditioner, an operation history regarding mode change of the air conditioner, an operation history regarding change of set temperature, or the like. The mode of the air conditioner includes a heating operation mode, a cooling operation mode, a dehumidifying operation mode, or the like.

When the IoT device 2-n is, for example, a rice cooker, the log data includes an operation history regarding the start or stop of rice cooking of the rice cooker, an operation history regarding the change of cooking course, an operation history regarding the change of reservation time, or the like. The cooking course includes a course related to rice cooking of white rice, rice cooking of brown rice, rice cooking of seasoned rice, or the like.

Furthermore, each IoT device 2-n outputs operation condition data indicating operation condition to the facility evaluation apparatus 6 via the line concentrator 4 and the network 5. In a case where the IoT device 2-n is, for example, an air conditioner, for example, data indicating a change in indoor temperature or the like over time can be considered as the operation condition data of the air conditioner. When the IoT device 2-n is, for example, an air cleaner, for example, data indicating a change in the concentration of carbon dioxide or the like in the room over time can be considered as the operation condition data of the air cleaner.

The sensors 3-m (m=1, . . . , M) are installed in each facility or attached to users staying in each facility.

Examples of the sensor installed in the facility include a human sensor that detects entrance and exit of a user or the like into and from each room in the facility, a smoke sensor that detects smoke, a temperature sensor that detects temperature, a carbon dioxide sensor that detects a concentration of carbon dioxide, and a bed sensor used to detect sleep of a user.

Examples of the sensor attached to a user include a vital sensor such as a blood pressure sensor, a body temperature sensor, and a heart rate sensor.

The sensor 3-m outputs, for example, sensor information indicating its own type to the facility evaluation apparatus 6 via the line concentrator 4 and the network 5. The sensor information indicating its own type indicates that the sensor is a human sensor when the sensor 3-m is, for example, a human sensor, and indicates that the sensor is a blood pressure sensor when the sensor 3-m is, for example, a blood pressure sensor that measures blood pressure.

The sensor 3-m outputs sensing data to the facility evaluation apparatus 6 via the line concentrator 4 and the network 5.

In a case where the sensor 3-m is a human sensor, the sensing data includes, for example, data indicating a time for a user or the like to enter or leave a room in the facility. If the sensor 3-m is a blood pressure sensor that measures blood pressure, the sensing data includes data indicating a change in blood pressure over time.

The line concentrator 4 is implemented by, for example, a hub that connects a plurality of network devices.

The line concentrator 4 is installed in each facility and is connected to each of the IoT devices 2-n and the sensors 3-m via a LAN or the like.

The line concentrator 4 transfers the installed device information, the log data, or the operation condition data output from the IoT device 2-n to the facility evaluation apparatus 6 via the network 5.

The line concentrator 4 transfers the sensor information or the sensing data output from the sensor 3-m to the facility evaluation apparatus 6 via the network 5.

The line concentrator 4 transfers, to the IoT device 2-n, operation information or the like for the IoT device 2-n transmitted from a smartphone or the like (not illustrated) possessed by a staff or the like of the facility.

The network 5 is a communication network implemented by the Internet, a LAN, or the like.

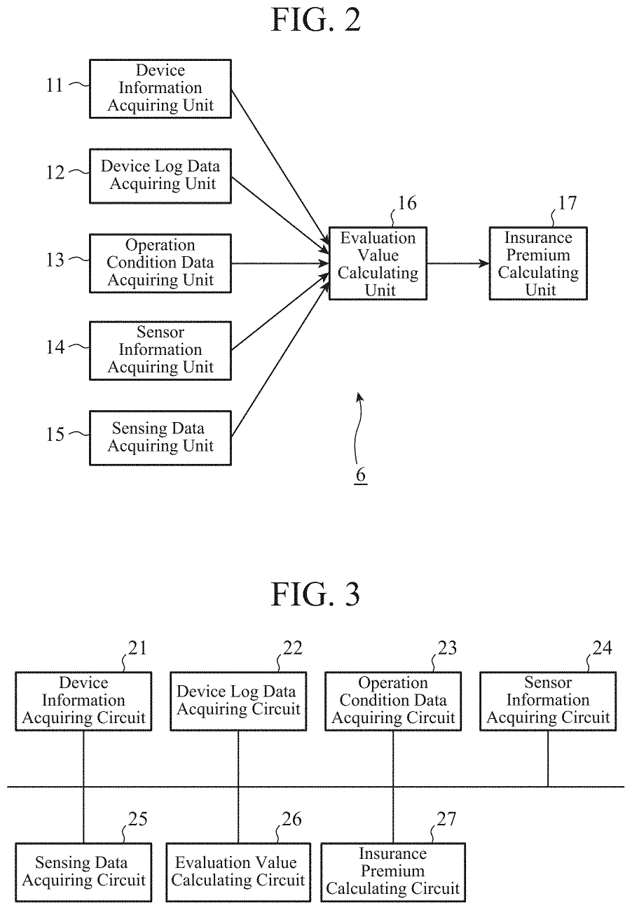

FIG. 2 is a configuration diagram illustrating the facility evaluation apparatus 6 according to the first embodiment.

FIG. 3 is a hardware configuration diagram illustrating hardware of the facility evaluation apparatus 6 according to the first embodiment.

The facility evaluation apparatus 6 is connected to the facility apparatuses 1-1 to 1-K via the network 5.

The facility evaluation apparatus 6 includes a device information acquiring unit 11, a device log data acquiring unit 12, an operation condition data acquiring unit 13, a sensor information acquiring unit 14, a sensing data acquiring unit 15, an evaluation value calculating unit 16, and an insurance premium calculating unit 17.

The facility evaluation apparatus 6 calculates an evaluation value indicating the value of the facility to be evaluated, and calculates the insurance premium for corporate insurance for the facility on the basis of the evaluation value.

As the corporate insurance for the facility, insurance for compensating for the injury or illness of the user due to the negligence of staffs of the facility, insurance for compensating for the failure of the IoT device 2-n or the like installed in the facility, or the like can be considered.

The device information acquiring unit 11 is implemented by, for example, a device information acquiring circuit 21 illustrated in FIG. 3.

The device information acquiring unit 11 acquires installed device information indicating each of a type and a function of each IoT device 2-n installed in each facility from the facility apparatuses 1-1 to 1-K.

The device information acquiring unit 11 outputs the installed device information to the evaluation value calculating unit 16.

The device log data acquiring unit 12 is implemented by, for example, a device log data acquiring circuit 22 illustrated in FIG. 3.

The device log data acquiring unit 12 acquires log data indicating an operation history of the IoT device 2-n installed in each facility from the facility apparatuses 1-1 to 1-K.

The device log data acquiring unit 12 outputs the log data to the evaluation value calculating unit 16.

The operation condition data acquiring unit 13 is implemented by, for example, an operation condition data acquiring circuit 23 illustrated in FIG. 3.

The operation condition data acquiring unit 13 acquires operation condition data indicating the operation condition of the IoT device 2-n installed in each facility from the facility apparatuses 1-1 to 1-K.

The operation condition data acquiring unit 13 outputs the operation condition data to the evaluation value calculating unit 16.

The sensor information acquiring unit 14 is implemented by, for example, a sensor information acquiring circuit 24 illustrated in FIG. 3.

The sensor information acquiring unit 14 acquires sensor information indicating the type of the sensor 3-m installed in each facility or the sensor 3-m attached to the user staying in the facility from the facility apparatuses 1-1 to 1-K.

The sensor information acquiring unit 14 outputs the sensor information to the evaluation value calculating unit 16.

The sensing data acquiring unit 15 is implemented by, for example, a sensing data acquiring circuit 25 illustrated in FIG. 3.

The sensing data acquiring unit 15 acquires the sensing data of the sensor 3-m installed in each facility or the sensor 3-m attached to the user from the facility apparatuses 1-1 to 1-K.

The sensing data acquiring unit 15 outputs the sensing data to the evaluation value calculating unit 16.

The evaluation value calculating unit 16 is implemented by, for example, an evaluation value calculating circuit 26 illustrated in FIG. 3.

The evaluation value calculating unit 16 acquires the installed device information from the device information acquiring unit 11, acquires the log data from the device log data acquiring unit 12, and acquires the operation condition data from the operation condition data acquiring unit 13.

Furthermore, the evaluation value calculating unit 16 acquires the sensor information from the sensor information acquiring unit 14 and acquires the sensing data from the sensing data acquiring unit 15.

The evaluation value calculating unit 16 calculates an evaluation value indicating the value of each facility on the basis of at least the installed device information.

The evaluation value calculating unit 16 may calculate the evaluation value on the basis of the log data, the operation condition data, the sensor information, or the sensing data, in addition to the installed device information.

The evaluation value calculating unit 16 outputs the evaluation value to the insurance premium calculating unit 17.

The insurance premium calculating unit 17 is implemented by, for example, an insurance premium calculating circuit 27 illustrated in FIG. 3.

The insurance premium calculating unit 17 acquires the evaluation value of each facility calculated by the evaluation value calculating unit 16.

The insurance premium calculating unit 17 calculates the insurance premium for the corporate insurance for each facility on the basis of the evaluation value of each facility.

In FIG. 2, it is assumed that each of the device information acquiring unit 11, the device log data acquiring unit 12, the operation condition data acquiring unit 13, the sensor information acquiring unit 14, the sensing data acquiring unit 15, the evaluation value calculating unit 16, and the insurance premium calculating unit 17, which are components of the facility evaluation apparatus 6, is implemented by dedicated hardware as illustrated in FIG. 3. That is, it is assumed that the facility evaluation apparatus 6 is implemented by the device information acquiring circuit 21, the device log data acquiring circuit 22, the operation condition data acquiring circuit 23, the sensor information acquiring circuit 24, the sensing data acquiring circuit 25, the evaluation value calculating circuit 26, and the insurance premium calculating circuit 27.

Each of the device information acquiring circuit 21, the device log data acquiring circuit 22, the operation condition data acquiring circuit 23, the sensor information acquiring circuit 24, the sensing data acquiring circuit 25, the evaluation value calculating circuit 26, and the insurance premium calculating circuit 27 corresponds to, for example, a single circuit, a composite circuit, a programmed processor, a parallel-programmed processor, an application specific integrated circuit (ASIC), a field-programmable gate array (FPGA), or a combination thereof.

The components of the facility evaluation apparatus 6 are not limited to those implemented by dedicated hardware, and the facility evaluation apparatus 6 may be implemented by software, firmware, or a combination of software and firmware.

The software or firmware is stored in a memory of a computer as a program. The computer means hardware that executes a program, and corresponds to, for example, a central processing unit (CPU), a central processing unit, a processing unit, an arithmetic unit, a microprocessor, a microcomputer, a processor, or a digital signal processor (DSP).

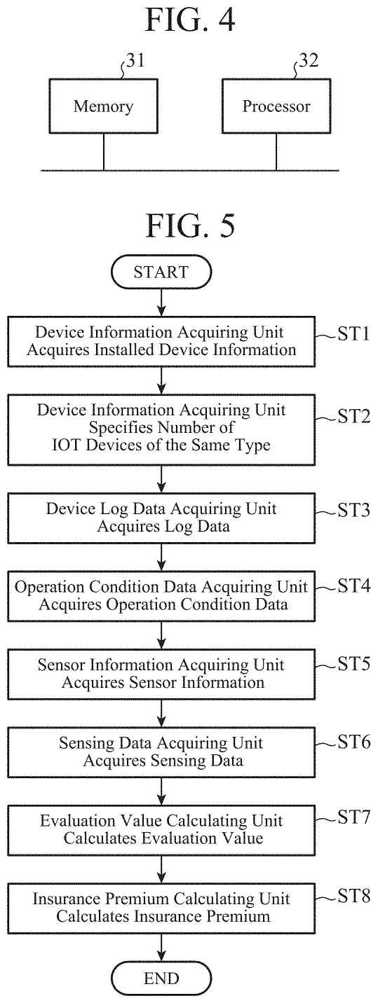

FIG. 4 is a hardware configuration diagram of a computer in a case where the facility evaluation apparatus 6 is implemented by software, firmware, or the like.

In a case where the facility evaluation apparatus 6 is implemented by software, firmware, or the like, a program for causing a computer to execute each processing procedure performed in the device information acquiring unit 11, the device log data acquiring unit 12, the operation condition data acquiring unit 13, the sensor information acquiring unit 14, the sensing data acquiring unit 15, the evaluation value calculating unit 16, and the insurance premium calculating unit 17 is stored in a memory 31. Then, a processor 32 of the computer executes the program stored in the memory 31.

In addition, FIG. 3 illustrates an example in which each of the components of the facility evaluation apparatus 6 is implemented by dedicated hardware, and FIG. 4 illustrates an example in which the facility evaluation apparatus 6 is implemented by software, firmware, or the like. However, this is merely an example, and some components in the facility evaluation apparatus 6 may be implemented by dedicated hardware, and the remaining components may be implemented by software, firmware, or the like.

Next, the operation of the facility evaluation system illustrated in FIG. 1 will be described.

FIG. 5 is a flowchart illustrating a facility evaluation method which is a processing procedure performed in the facility evaluation apparatus 6 illustrated in FIG. 2.

The IoT device 2-n (n=1, . . . , N) of the facility apparatus 1-k (k=1, . . ., K) outputs installed device information indicating each of its own type and function to the facility evaluation apparatus 6 via the line concentrator 4 and the network 5.

The IoT device 2-n stores log data indicating an operation history in, for example, an internal memory.

The IoT device 2-n outputs the log data stored in the internal memory to the facility evaluation apparatus 6 via the line concentrator 4 and the network 5 at regular time intervals, when receiving a transmission request of the log data from the facility evaluation apparatus 6, or when receiving an operation by a user staying in the facility or an operation by a staff of the facility.

Furthermore, the IoT device 2-n stores operation condition data indicating an operation condition in an internal memory, for example.

The IoT device 2-n outputs the operation condition data stored in the internal memory to the facility evaluation apparatus 6 via the line concentrator 4 and the network 5 at regular time intervals or when receiving a transmission request of the operation condition data from the facility evaluation apparatus 6.

The sensor 3-m (m=1, . . . , M) outputs sensor information indicating its own type to the facility evaluation apparatus 6 via the line concentrator 4 and the network 5.

The sensor 3-m stores sensing data in, for example, an internal memory.

The sensor 3-m outputs the sensing data stored in the internal memory to the facility evaluation apparatus 6 via the line concentrator 4 and the network 5 at regular time intervals, when receiving a transmission request of the sensing data from the facility evaluation apparatus 6, or when performing sensing.

The device information acquiring unit 11 acquires installed device information indicating each of a type and a function of the IoT device 2-n installed in each facility from the facility apparatuses 1-1 to 1-K (step ST1 in FIG. 5).

The device information acquiring unit 11 specifies the number of IoT devices of the same type among the IoT devices 2-1 to 2-N included in the facility apparatus 1-k on the basis of the installed device information (step ST2 in FIG. 5).

That is, the device information acquiring unit 11 specifies the number of air conditioners, the number of air cleaners, the number of ventilation fans, the number of IH cookers, the number of rice cookers, the number of cleaners, the number of floor wiping robots, the number of bathroom water heaters, the number of bathroom heaters, the number of televisions, the number of audio devices, the number of digital cameras, the number of video cameras, the number of lighting instruments, and the like included in the facility apparatus 1-k.

The device information acquiring unit 11 includes information indicating the number of IoT devices 2-n of the same type in the installed device information, and outputs the installed device information indicating each of the type, the function, and the number to the evaluation value calculating unit 16.

The device log data acquiring unit 12 acquires log data indicating the operation history of the IoT device 2-n installed in each facility from the facility apparatuses 1-1 to 1-K (step ST3 in FIG. 5).

The device log data acquiring unit 12 outputs the log data to the evaluation value calculating unit 16.

The operation condition data acquiring unit 13 acquires operation condition data indicating the operation condition of the IoT device 2-n installed in each facility from the facility apparatuses 1-1 to 1-K (step ST4 in FIG. 5).

The operation condition data acquiring unit 13 outputs the operation condition data to the evaluation value calculating unit 16.

The sensor information acquiring unit 14 acquires the sensor information indicating the types of the sensors 3-m installed in each facility or the sensors 3-m attached to users staying in each facility from the facility apparatuses 1-1 to 1-K (step ST5 in FIG. 5).

The sensor information acquiring unit 14 outputs the sensor information to the evaluation value calculating unit 16.

The sensing data acquiring unit 15 acquires the sensing data of the sensors 3-m installed in each facility or the sensors 3-m attached to users from the facility apparatuses 1-1 to 1-K (step ST6 in FIG. 5).

The sensing data acquiring unit 15 outputs the sensing data to the evaluation value calculating unit 16.

The information acquisition interval in each of the device information acquiring unit 11 and the sensor information acquiring unit 14 and the data acquisition interval in each of the device log data acquiring unit 12, the operation condition data acquiring unit 13, and the sensing data acquiring unit 15 are not particularly limited. As the acquisition interval of the information or data, once per hour, once per month, once per year, or the like can be considered.

The evaluation value calculating unit 16 acquires the installed device information from the device information acquiring unit 11, acquires the log data from the device log data acquiring unit 12, and acquires the operation condition data from the operation condition data acquiring unit 13.

Furthermore, the evaluation value calculating unit 16 acquires the sensor information from the sensor information acquiring unit 14 and acquires the sensing data from the sensing data acquiring unit 15.

The evaluation value calculating unit 16 calculates an evaluation value indicating the value of each facility on the basis of at least the installed device information (step ST7 in FIG. 5).

Hereinafter, calculation processing of the evaluation value by the evaluation value calculating unit 16 will be specifically described.

In the facility evaluation system illustrated in FIG. 1, description will be given on the assumption that the types of IoT devices 2-n that may be included in the facility are 14 types of an air conditioner, an air cleaner, a ventilation fan, an IH cooker, a rice cooker, a cleaner, a floor wiping robot, a bathroom water heater, a bathroom heater, a television, an audio device, a digital camera, a video camera, and a lighting instrument. However, this is merely an example, and the types of the IoT devices 2-n that may be included in the facility may be different from 14 types, or each facility may include the IoT devices 2-n different from the 14 types of IoT devices 2-n described above.

(1) Calculation Example of Evaluation Value (1)

The calculation example of evaluation value (1) illustrates simple evaluation value calculation processing performed by the evaluation value calculating unit 16.

The evaluation value calculating unit 16 acquires the installed device information of the IoT devices 2-n (n=1, . . . , N) included in the facility apparatus 1-k from the device information acquiring unit 11.

The evaluation value calculating unit 16 sets score SC_{k,n} corresponding to importance level of the IoT device 2-n included in the facility apparatus 1-k on the basis of the type of the IoT device 2-n indicated by the installed device information. The score SC_{k,n} is set to a larger value as the importance level of the IoT device 2-n is higher.

The importance level of the IoT device 2-n is set in advance, and is stored in the internal memory of the evaluation value calculating unit 16, for example. For example, among the 14 types of IoT devices 2-n described above, the air conditioner is considered to have the highest importance level, and the air cleaner, the lighting instrument, . . . , and the floor wiping robot are considered to have the second highest and subsequent importance levels in this order.

The evaluation value calculating unit 16 calculates the sum SCₖ of the scores SC_{k,1} to SC_{k,14} as expressed in the following Formula (1).

SCₖ=SC_{k,1}+SC_{k,2}+SC_{k,3}+ . . . +SC_{k,14} (1)

In Formula (1), SC_{k,1} is a score in a case where the facility apparatus 1-k includes the air conditioner, and if the facility apparatus 1-k does not include the air conditioner, SC_{k,1} is “0”.

SC_{k,2} is a score in a case where the facility apparatus 1-k includes the air cleaner, and when the facility apparatus 1-k does not include the air cleaner, SC_{k,2} is “0”.

SC_{k,3} is a score in a case where the facility apparatus 1-k includes the ventilation fan, and if the facility apparatus 1-k does not include the ventilation fan, SC_{k,3} is “0”.

Similarly to SC_{k,1} to SC_{k,3}, SC_{k,4} to SC_{k,14} are scores in a case where the facility apparatus 1-k includes the corresponding IoT device 2-n, and when the facility apparatus 1-k does not include the corresponding IoT device 2-n, SC_{k,4} to SC_{k,14} are “0”.

Note that SC_{k,4} is a score related to the IH cooker, SC_{k,5} is a score related to the rice cooker, SC_{k,6} is a score related to the cleaner, and SC_{k,7} is a score related to the floor wiping robot.

Further, SC_{k,8} is a score related to the bathroom water heater, SC_{k,9} is a score related to the bathroom heater, SC_{k,10} is a score related to the television, and SC_{k,11} is a score related to the audio device. SC_{k,12} is a score related to the digital camera, SC_{k,13} is a score related to the video camera, and SC_{k,14} is a score related to the lighting instrument.

As described above, the score SC_{k,n} is set to a larger value as the importance level of the IoT device 2-n is higher, but if the facility apparatus 1-k includes all the 14 types of IoT devices 2-n, the value of the score SC_{k,n} is adjusted so that the sum SCₖ of the scores SC_{k,1} to SC_{k,14} is, for example, 100 points.

When the sum SCₖ of the scores SC_{k,1} to SC_{k,14} for the facility apparatuses 1-1 to 1-K is calculated, the evaluation value calculating unit 16 calculates a deviation value Tₖ of each sum SCₖ as shown in the following Formula (2). However, when K=1, the deviation value Tₖ is set to 50, for example.

$${T}_{k} = \frac{10 ( S {C}_{k} - {μ}_{x} )}{{σ}_{x}} + 50 \qquad ( 2 )$$

$${μ}_{x} = \frac{1}{K} {\sum }_{k = 1}^{K} S {C}_{k}$$

$${σ}_{x} = \sqrt{\frac{1}{K} {\sum }_{k = 1}^{K} {( {SC}_{k} - {μ}_{x} )}^{2}}$$

The evaluation value calculating unit 16 outputs the deviation value Tₖ of each sum SCₖ to the insurance premium calculating unit 17 as an evaluation value Eₖ indicating the evaluation of each facility as expressed in the following Formula (3).

Eₖ=Tₖ (3)

(2) Calculation Example of Evaluation Value (2)

In the calculation example (2) of the evaluation value, the evaluation value calculating unit 16 corrects the score SC_{k,n} using weight value wa_{k,n} corresponding to the function of the IoT device 2-n, so that the calculation processing of the evaluation value Eₖ is performed with higher accuracy than in the calculation example (1).

The evaluation value calculating unit 16 acquires the installed device information of the IoT device 2-n (n=1, . . . , N) included in the facility apparatus 1-k from the device information acquiring unit 11.

The evaluation value calculating unit 16 sets the weight value wa_{k,n} of the IoT device 2-n on the basis of the function of the IoT device 2-n indicated by the installed device information.

Here, an example in which weight value wa_{k,1} of the air conditioner is set on the assumption that the IoT device 2-n is an air conditioner, and an example in which weight value wa_{k,10} of the television is set on the assumption that the IoT device 2-n is a television will be described.

If the IoT device 2-n is an air conditioner, the evaluation value calculating unit 16 sets the weight value wa_{k,1} of the air conditioner on the basis of the function of the air conditioner.

Specifically, it is assumed that the evaluation value calculating unit 16 has w(1) as a weighting element when the air conditioner has the cooling function, w(2) as a weighting element when the air conditioner has the heating function, and w(3) as a weighting element when the air conditioner has the dehumidifying function. In addition, it is assumed that the evaluation value calculating unit 16 has w(4) as a weighting element when the air conditioner has the sterilization function, and has w(5) as a weighting element when the air conditioner has the remote operation receiving function.

The evaluation value calculating unit 16 calculates the sum of weighting elements related to the functions of the air conditioner as the weight value wa_{k,1} of the air conditioner as expressed in the following Formula (4).

wa_{k,1}=w(1)+w(2)+w(3)+w(4)+w(5) (4)

When the air conditioner has all the functions of the cooling function, the heating function, the dehumidifying function, the sterilization function, and the remote operation receiving function, for example, each of the weighting elements w(1), w(2), w(3), w(4), and w(5) is set so that the weight value wa_{k,1} is “1.0”.

If the IoT device 2-n is a television, the evaluation value calculating unit 16 sets the weight value wa_{k,10} of the television on the basis of the function of the television.

Specifically, it is assumed that the evaluation value calculating unit 16 has w(6) as a weighting element when the television has the television viewing function, and has w(7) as a weighting element when the television has the web browsing function. In addition, it is assumed that the evaluation value calculating unit 16 has w(8) as a weighting element when the television has a recording function, and has w(9) as a weighting element when the television has a remote operation receiving function.

The evaluation value calculating unit 16 calculates the sum of weighting elements related to functions of the television as the television weight value wa_{k,10} as expressed in the following Formula (5).

wa_{k,10}=w(6)+w(7)+w(8)+w(9) (5)

If the IoT device 2-n has all the functions of the television viewing function, the web browsing function, the recording function, and the remote operation receiving function, for example, each of the weighting elements w(6), w(7), w(8), and w(9) is set so that the weight value wa_{k,10} is “1.0”.

When setting the weight values wa_{k,n} corresponding to the functions of the 14 types of IoT devices 2-n, the evaluation value calculating unit 16 calculates the sum SCₖ of the scores SC₁ to SC₁₄ using the weight values wa_{k,n} as illustrated in the following Formula (6).

SCₖ=SC_{k,1}×wa_{k,1}+SC_{k,2}×wa_{k,2}+SC_{k,3}×wa_{k,3}+ . . . +SC_{k,14}×wa_{k,14} (6)

When calculating the sum SCₖ of the scores SC_{k,1} to SC_{k,14} for the facility apparatuses 1-1 to 1-K, the evaluation value calculating unit 16 calculates a deviation value Tₖ of each sum SCₖ as shown in Formula (2).

After calculating the deviation value Tₖ of each of the sums SCₖ, the evaluation value calculating unit 16 outputs the deviation value Tₖ of each of the sums SCₖ to the insurance premium calculating unit 17 as an evaluation value Eₖ indicating the evaluation of each facility as expressed in Formula (3).

(3) Calculation Example of Evaluation Value (3)

In the calculation example (3) of the evaluation value, the score SC_{k,n} is corrected using the weight value wb_{k,n} corresponding to the number of IoT devices 2-n of the same type included in the facility apparatus 1-k, so that the calculation processing of the evaluation value Eₖ is performed with higher accuracy than in the calculation example (1).

The evaluation value calculating unit 16 acquires the installed device information of the IoT device 2-n (n=1, . . . , N) included in the facility apparatus 1-k from the device information acquiring unit 11.

The evaluation value calculating unit 16 grasps the number of IoT devices 2-n of the same type included in the facility apparatus 1-k on the basis of the number of devices indicated by the installed device information.

That is, the evaluation value calculating unit 16 grasps the number of air conditioners, the number of air cleaners, the number of ventilation fans, the number of IH cookers, the number of rice cookers, the number of cleaners, the number of floor wiping robots, the number of bathroom water heaters, the number of bathroom heaters, the number of televisions, the number of audio devices, the number of digital cameras, the number of video cameras, and the number of lighting instruments included in the facility apparatus 1-k.

Here, an example of setting weight value wb_{k,2} of the air cleaner assuming that the IoT device 2-n is the air cleaner and an example of setting weight value wb_{k,10} of the television assuming that the IoT device 2-n is the television will be described.

If the IoT device 2-n is an air cleaner, the evaluation value calculating unit 16 sets the weight value wb_{k,2} of the air cleaner on the basis of the number C_{k,2} of air cleaners installed in each facility.

That is, when the number of rooms in the facility in which the facility apparatus 1-k is installed is Dₖ, the evaluation value calculating unit 16 calculates the weight value wb_{k,2} of the air cleaner by substituting, for example, the number of rooms Dₖ and the number of air cleaners C_{k,2} into the following Formula (7). The number of rooms Dₖ may be stored, for example, in an internal memory of the evaluation value calculating unit 16 or may be given from the outside of the facility evaluation apparatus 6.

wb_{k,2}=C_{k,2}/Dₖ (7)

The number of rooms D includes a room in a common space of a facility in addition to a room in which each user stays. The room of the common space includes an entertainment room of the facility, a dressing room of a common bathroom, and the like in addition to the lobby of the facility.

If the IoT device 2-n is a television, the evaluation value calculating unit 16 sets the weight value wb_{k,10} of the television on the basis of the number of televisions C_{k,10} installed in each facility.

That is, the evaluation value calculating unit 16 calculates the television weight value wb_{k,10} by substituting, for example, the number of rooms Dₖ and the number of televisions C_{k,10} into the following Formula (8).

wb_{k,10}=C_{k,10}/Dₖ (8)

When setting the weight value wb_{k,n} corresponding to the number of IoT devices 2-n of the same type, the evaluation value calculating unit 16 calculates the sum SCₖ of the scores SC₁ to SC₁₄ using the weight value wb_{k,n} as expressed in the following Formula (9) or Formula (10), for example.

SCₖ=SC_{k,1}×wb_{k,1}+SC_{k,2}×wb_{k,2}+SC_{k,3}×wb_{k,3}+ . . . +SC_{k,14}×wb_{k,14} (9)

SCₖ=SC_{k,1}×wa_{k,1}×wb_{k,1}+SC_{k,2}×wa_{k,2}×wb_{k,2}+SC_{k,3}×wa_{k,3}×wb_{k,3}+ . . . +SC_{k,14}×wa_{k,14}×wb_{k,14} (10)

When calculating the sum SCₖ of the scores SC_{k,1} to SC_{k,14} for the facility apparatuses 1-1 to 1-K, the evaluation value calculating unit 16 calculates a deviation value Tₖ of each sum SCₖ as shown in Formula (2).

After calculating the deviation value Tₖ of each of the sums SCₖ, the evaluation value calculating unit 16 outputs the deviation value Tₖ of each of the sums SCₖ to the insurance premium calculating unit 17 as an evaluation value Eₖ indicating the evaluation of each facility as expressed in Formula (3).

(4) Calculation Example of Evaluation Value (4)

In the calculation example (4) of the evaluation value, by correcting the score SC_{k,n} using the weight value wc_{k,n} corresponding to the log data of the IoT device 2-n, the calculation processing of the evaluation value Eₖ is performed with higher accuracy than in the calculation example (1).

The evaluation value calculating unit 16 acquires the log data of the IoT device 2-n (n=1, . . . , N) included in the facility apparatus 1-k from the device log data acquiring unit 12.

Here, an example of setting weight value wc_{k,1} of the air conditioner assuming that the IoT device 2-n is the air conditioner, an example of setting weight value wc_{k,3} of the ventilation fan assuming that the IoT device 2-n is the ventilation fan, and an example of setting weight value wc_{k,4} of the IH cooker assuming that the IoT device 2-n is the IH cooker will be described.

In a case where the IoT device 2-n is an air conditioner, when the current temperature is a high temperature of, for example, 30 degrees or more, if the log data of the air conditioner indicates that the cooling operation mode is being executed, it can be considered that the air conditioner is properly used.

On the other hand, for example, when the log data of the air conditioner indicates that the heating operation mode is being executed, it can be considered that the air conditioner is improperly used. If improper use of the air conditioner continues for a long time, there is a risk that the user may get heat stroke. If a staff member or the like of the facility notices improper use of the air conditioner in a short time and performs the operation for stopping the air conditioner operation, an operation for switching the mode of the air conditioner to the cooling operation mode, or the like, it can be considered that the support to users is excellent and the facility is good. If a staff member or the like of the facility does not notice the improper use of the air conditioner and does not perform the operation for stopping the air conditioner operation, the operation for switching the mode of the air conditioner to the cooling operation mode, or the like, it can be considered that the support to users is poor and the facility is not good.

Information regarding an operation for stopping the air conditioner operation, an operation for switching the mode of the air conditioner to the cooling operation mode, or the like is obtained from the log data. Whether or not the operation is performed by the staff members or the like of the facility can be grasped on the basis of whether or not the remote operation receiving function of the air conditioner has received the operation by, for example, a smartphone or the like of a staff member or the like of the facility.

In addition, if the log data of the air conditioner indicates that the heating operation mode is being executed when the current temperature is a low temperature of, for example, 10 degrees or less, it can be considered that the air conditioner is properly used.

On the other hand, for example, when the log data of the air conditioner indicates that the cooling operation mode is being executed, it can be considered that the air conditioner is improperly used. If improper use of the air conditioner continues for a long time, there is a risk that a user will have hypothermia. If a staff member or the like of the facility notices improper use of the air conditioner in a short time and performs an operation for stopping the air conditioner operation, an operation for switching the mode of the air conditioner to the heating operation mode, or the like, it can be considered that the support to users is excellent and the facility is good. If a staff member or the like of the facility does not notice the improper use of the air conditioner and does not perform the operation for stopping the air conditioner operation, the operation for switching the mode of the air conditioner to the heating operation mode, or the like, it can be considered that the support to users is poor and the facility is not good.

Information regarding an operation for stopping the air conditioner operation, an operation for switching the mode of the air conditioner to the heating operation mode, or the like is obtained from the log data.

The evaluation value calculating unit 16 sets, for example, a value of 0.8 or more as the weight value wc_{k,1} of the air conditioner when the log data of the air conditioner indicates the improper use of the air conditioner, and if a staff member of the facility performs the operation to stop the improper use or the operation to switch to the proper use before the improper use time period exceeds a threshold Th₁. The threshold Th₁ may be stored in the internal memory of the evaluation value calculating unit 16 or may be given from the outside of the facility evaluation apparatus 6.

The evaluation value calculating unit 16 may set a higher value as the weight value wc_{k,1} of the air conditioner as the time from the start of improper use of the air conditioner until the operation to stop improper use or the operation to switch to proper use is shorter. When the threshold Th₁ is, for example, 1 hour, if a staff member or the like of the facility performs an operation to stop improper use within, for example, 15 minutes after log data of the air conditioner indicates improper use, the evaluation value calculating unit 16 sets 1.2 as the weight value wc_{k,1} of the air conditioner. If a staff member or the like of the facility performs an operation or the like to stop improper use within, for example, 15 minutes or more and 30 minutes or less after log data of the air conditioner indicates improper use, the evaluation value calculating unit 16 sets 1.0 as the weight value wc_{k,1} of the air conditioner. If a staff member or the like of the facility performs an operation or the like to stop improper use within, for example, 30 minutes or more and 45 minutes or less after log data of the air conditioner indicates improper use, the evaluation value calculating unit 16 sets 0.8 as the weight value wc_{k,1} of the air conditioner.

If a staff member or the like of the facility does not perform an operation to stop improper use even when the improper use time period exceeds the threshold Th₁, the evaluation value calculating unit 16 sets, for example, a value less than 0.5 as the weight value wc_{k,1} of the air conditioner.

It is assumed that the IoT device 2-n is the ventilation fan and the sensor 3-m is a carbon dioxide sensor. When the sensing data of the carbon dioxide sensor indicates that high concentration carbon dioxide has been detected, if the log data of the ventilation fan indicates that the ventilation fan is operating, it can be considered that the ventilation fan is properly used.

On the other hand, when the carbon dioxide sensor indicates that high concentration carbon dioxide has been detected, if the log data of the ventilation fan indicates that the ventilation fan is not operated, it can be considered that the ventilation fan is not properly used. If the ventilation fan is not properly used for a long time, there is a risk that users will suffer from carbon dioxide poisoning. If a staff member or the like of the facility notices in a short time a state in which the ventilation fan is not properly used and performs an operation for starting the ventilation fan operation, it can be considered that the support to users is excellent and the facility is good. If a staff member or the like of the facility does not notice the state in which the ventilation fan is not properly used and does not perform the operation for starting the ventilation fan operation, it can be considered that the support to users is poor and the facility is not good.

Information regarding the operation for starting the ventilation fan operation is obtained from the log data. Whether or not the operation is performed by the staff members or the like of the facility can be grasped by, for example, whether or not the remote operation receiving function of the ventilation fan receives the operation using a smartphone or the like of a staff member or the like of the facility.

When the log data of the ventilation fan indicates that the ventilation fan is not properly used, and if a staff member or the like of the facility performs an operation to start operating the ventilation fan before the time period during which the ventilation fan is not properly used exceeds a threshold Th₂, the evaluation value calculating unit 16 sets a value of 0.8 or more, for example, as the weight value wc_{k,3} of the ventilation fan. The threshold Th₂ may be stored in the internal memory of the evaluation value calculating unit 16 or may be given from the outside of the facility evaluation apparatus 6.

The evaluation value calculating unit 16 may set a higher value as the weight value wc_{k,3} of the ventilation fan as the time from when the carbon dioxide sensor detects high concentration carbon dioxide to when the operation for starting the ventilation fan operation is performed is shorter. When the threshold Th₂ is, for example, 30 minutes, if a staff member or the like of the facility performs an operation for starting the ventilation fan operation within, for example, 15 minutes after the carbon dioxide sensor detects high concentration carbon dioxide, 1.2 is set as the weight value wc_{k,3} of the ventilation fan. When a staff member or the like of the facility performs an operation for starting the ventilation fan operation within, for example, 15 minutes or more and 30 minutes or less after the carbon dioxide sensor detects high concentration carbon dioxide, 1.0 is set as the weight value wc_{k,3} of the ventilation fan.

The evaluation value calculating unit 16 sets, for example, a value less than 0.5 as the weight value wc_{k,3} of the ventilation fan if a staff member or the like of the facility does not perform the operation for starting the ventilation fan operation even after 30 minutes have passed since the carbon dioxide sensor detects high concentration carbon dioxide.

In a case where the IoT device 2-n is an IH cooker, if the log data of the IH cooker indicates that the use time of the IH cooker is within a certain period of time, it can be considered that the IH cooker is properly used. The certain period of time may be 30 minutes, 1 hour, or the like.

On the other hand, if it is indicated that the use time of the IH cooker exceeds the certain period of time, improper use such as forgetting to turn off the IH cooker is considered. If the IH cooker is improperly used, there is a risk of fire or carbon monoxide poisoning of users. If a staff member or the like of the facility notices in a short time a state in which the IH cooker is improperly used and performs an operation to stop using the IH cooker, it can be considered that the support to users is excellent and the facility is good. If a staff member or the like of the facility does not notice a state in which the IH cooker is improperly used and does not perform an operation to stop using the IH cooker, it can be considered that the support to users is poor and the facility is not good.

Information regarding the operation to stop using the IH cooker is obtained from the log data. Whether or not the operation is performed by the staff members or the like of the facility can be grasped on the basis of, for example, whether or not the remote operation receiving function of the IH cooker has received the operation by a smartphone or the like of a staff member or the like of the facility.

When the log data of the IH cooker indicates that the IH cooker is improperly used, and if a staff member or the like of the facility performs an operation to stop using the IH cooker before the time period in which the IH cooker is improperly used exceeds a threshold Th₃, the evaluation value calculating unit 16 sets, for example, a value of 1.0 or more as the weight value wc_{k,4} of the IH cooker. The threshold Th₃ may be stored in the internal memory of the evaluation value calculating unit 16 or may be given from the outside of the facility evaluation apparatus 6.

If a staff member or the like of the facility does not perform the operation to stop using the IH cooker even when the time period in which the IH cooker is improperly used exceeds the threshold Th₃, the evaluation value calculating unit 16 sets, for example, a value less than 0.5 as the weight value wc_{k,4} of the IH cooker.

When setting the weight value wc_{k,n} corresponding to the log data of the IoT device 2-n, the evaluation value calculating unit 16 calculates the sum SCₖ of the scores SC₁ to SC₁₄ using the weight value wc_{k,n} as illustrated in the following Formula (11), Formula (12), or Formula (13).

SCₖ=SC_{k,1}×wc_{k,1}+SC_{k,2}×wc_{k,2}+SC_{k,3}×wc_{k,3}+ . . . +SC_{k,14}×wc_{k,14} (11)

SCₖ=SC_{k,1}×wa_{k,1}×wc_{k,1}+SC_{k,2}×wa_{k,2}×wc_{k,2}+SC_{k,3}×wa_{k,3}×wc_{k,3}+ . . . +SC_{k,14}×wa_{k,14}×wc_{k,14} (12)

SCₖ=SC_{k,1}×wa_{k,1}×wb_{k,1}×wc_{k,1}+SC_{k,2}×wa_{k,2}×wb_{k,2}×wc_{k,2}+SC_{k,3}×wa_{k,3}×wb_{k,3}×wc_{k,3}+ . . . +SC_{k,14}×wa_{k,14}×wb_{k,14}×wc_{k,14} (13)

When calculating the sum SCₖ of the scores SC_{k,1} to SC_{k,14} for the facility apparatuses 1-1 to 1-K, the evaluation value calculating unit 16 calculates a deviation value Tₖ of each sum SCₖ as shown in Formula (2).

After calculating the deviation value Tₖ of each of the sums SCₖ, the evaluation value calculating unit 16 outputs the deviation value Tₖ of each of the sums SCₖ to the insurance premium calculating unit 17 as an evaluation value Eₖ indicating the evaluation of each facility as expressed in Formula (3).

(5) Calculation Example of Evaluation Value (5)

In the calculation example (5) of the evaluation value, the score SC_{k,n} is corrected using weight value wd_{k,n} corresponding to the operation condition data of the IoT device 2-n, so that the calculation processing of the evaluation value Eₖ is performed with higher accuracy than in the calculation example (1).

The evaluation value calculating unit 16 acquires the operation condition data of the IoT device 2-n (n=1, . . . , N) included in the facility apparatus 1-k from the operation condition data acquiring unit 13.

Here, an example in which the weight value wd_{k,1} of the air conditioner is set on the assumption that the IoT device 2-n is the air conditioner and an example in which the weight value wd_{k,2} of the air cleaner is set on the assumption that the IoT device 2-n is the air cleaner will be described.

In a case where the IoT device 2-n is an air conditioner, data indicating a change in the indoor temperature or the like over time is obtained as the operation condition data of the air conditioner.

In a case where the temperature indicated by the operation condition data is higher than the upper limit temperature as the alarm temperature, or in a case where the temperature indicated by the operation condition data is lower than the lower limit temperature as the alarm temperature, it can be considered that the air conditioner is not properly used. The upper limit temperature may be, for example, 32 degrees, and the lower limit temperature may be, for example, 5 degrees.

If the time period in which the air conditioner is not properly used continues for a long time, that is, if the time period in which the temperature indicated by the operation condition data exceeds the upper limit temperature exceeds a threshold Th₄, there is a risk that a user will have heat stroke. If the time period in which the temperature indicated by the operation condition data is lower than the lower limit temperature exceeds a threshold Th₅, there is a risk that a user will have hypothermia. Each of the threshold Th₄ and the threshold Th₅ may be stored in the internal memory of the evaluation value calculating unit 16 or may be given from the outside of the facility evaluation apparatus 6.

If a staff member or the like of the facility notices in a short time improper use of the air conditioner and performs an operation to start proper use of the air conditioner, it can be considered that the support to users is excellent and the facility is good. As the proper use of the air conditioner, execution of the cooling operation mode at a proper set temperature when the temperature indicated by the operation condition data exceeds the upper limit temperature can be considered. When the temperature indicated by the operation condition data is lower than the lower limit temperature, execution of the heating operation mode at a proper set temperature can be considered as the proper use of the air conditioner.

If a staff member or the like of the facility does not notice the improper use of the air conditioner and does not perform the operation to start the proper use of the air conditioner, it can be considered that the support to users is poor and the facility is not good.

Information regarding the operation to start the proper use of the air conditioner is obtained from the log data. Whether or not the operation is performed by the staff members or the like of the facility can be grasped on the basis of whether or not the remote operation receiving function of the air conditioner has received the operation by, for example, a smartphone or the like of a staff member or the like of the facility.

The evaluation value calculating unit 16 sets, for example, a value of 0.8 or more as the weight value wd_{k,1} of the air conditioner if a staff member or the like of the facility performs the operation to start the proper use of the air conditioner before the time period in which the temperature indicated by the operation condition data of the air conditioner exceeds the upper limit temperature exceeds the threshold Th₄. The evaluation value calculating unit 16 may set a higher value as the weight value wd_{k,1} of the air conditioner as the time from when the temperature indicated by the operation condition data exceeds the upper limit temperature to when the proper use is started is shorter. When the threshold Th₄ is, for example, 1 hour, if a staff member or the like of the facility performs an operation to start proper use of the air conditioner within, for example, 15 minutes after the temperature indicated by the operation condition data of the air conditioner exceeds the upper limit temperature, 1.2 is set as the weight value wd_{k,1} of the air conditioner. If a staff member or the like of the facility performs an operation to start proper use of the air conditioner within, for example, 15 minutes or more and 30 minutes or less after the temperature indicated by the operation condition data of the air conditioner exceeds the upper limit temperature, 1.0 is set as the weight value wd_{k,1} of the air conditioner. If a staff member or the like of the facility performs an operation to start proper use of the air conditioner within, for example, 30 minutes or more and 45 minutes or less after the temperature indicated by the operation condition data of the air conditioner exceeds the upper limit temperature, 0.8 is set as the weight value wd_{k,1} of the air conditioner.

If a staff member or the like of the facility does not perform the operation to start the proper use of the air conditioner even when the time period in which the temperature indicated by the operation condition data of the air conditioner exceeds the upper limit temperature exceeds the threshold Th₄, the evaluation value calculating unit 16 sets, for example, a value less than 0.5 as the weight value wd_{k,1} of the air conditioner.

The evaluation value calculating unit 16 sets, for example, a value of 0.8 or more as the weight value wd_{k,1} of the air conditioner if a staff member or the like of the facility performs the operation to start the proper use of the air conditioner before the time period in which the temperature indicated by the operation condition data of the air conditioner is lower than the lower limit temperature exceeds the threshold Th₅. The evaluation value calculating unit 16 may set a higher value as the weight value wd_{k,1} of the air conditioner as the time from when the temperature indicated by the operation condition data falls below the lower limit temperature to when the proper use is started is shorter. When the threshold Th₅ is, for example, 1 hour, if a staff member or the like of the facility performs an operation to start proper use of the air conditioner within, for example, 15 minutes after the temperature indicated by the operation condition data of the air conditioner falls below the lower limit temperature, 1.2 is set as the weight value wd_{k,1} of the air conditioner. If a staff member or the like of the facility performs an operation to start proper use of the air conditioner within, for example, 15 minutes or more and 30 minutes or less after the temperature indicated by the operation condition data of the air conditioner falls below the lower limit temperature, 1.0 is set as the weight value wd_{k,1} of the air conditioner. If a staff member or the like of the facility performs an operation to start proper use of the air conditioner within, for example, 30 minutes or more and 45 minutes or less after the temperature indicated by the operation condition data of the air conditioner falls below the lower limit temperature, 0.8 is set as the weight value wd_{k,1} of the air conditioner.

If a staff member or the like of the facility does not perform the operation to start the proper use of the air conditioner even when the time period in which the temperature indicated by the operation condition data of the air conditioner is lower than the lower limit temperature exceeds the threshold Th₅, the evaluation value calculating unit 16 sets, for example, a value less than 0.5 as the weight value wd_{k,1} of the air conditioner.

In a case where the IoT device 2-n is an air cleaner, data indicating a change in the carbon dioxide concentration in the room over time is obtained as the operation condition data of the air cleaner.

When the carbon dioxide concentration indicated by the operation condition data exceeds alarm concentration, it can be considered that the air cleaner is not properly used.

If the time period in which the air cleaner is not properly used continues for a long time, that is, if the time period in which the carbon dioxide concentration indicated by the operation condition data exceeds the alarm concentration exceeds a threshold Th₆, there is a risk that a user will suffer from carbon dioxide poisoning. The threshold Th₆ may be stored in the internal memory of the evaluation value calculating unit 16 or may be given from the outside of the facility evaluation apparatus 6.

If a staff member or the like of the facility notices in a short time a state in which the air cleaner is not properly used and performs an operation to start proper use of the air cleaner, it can be considered that the support to users is excellent and the facility is good. If a staff member or the like of the facility does not notice that the air cleaner is not properly used and does not perform the operation to start the proper use of the air cleaner, it can be considered that the support to users is poor and the facility is not good.

Information regarding the operation to start proper use of the air cleaner is obtained from the log data. Whether or not the operation is performed by the staff members or the like of the facility can be grasped by, for example, whether or not the remote operation receiving function of the air cleaner has received the operation using a smartphone or the like of a staff member or the like of the facility.

The evaluation value calculating unit 16 sets, for example, a value of 1.0 or more as the weight value wd_{k,2} of the air cleaner if a staff member or the like of the facility performs an operation to start proper use of the air cleaner before the time period in which the carbon dioxide concentration indicated by the operation condition data of the air cleaner exceeds the alarm concentration exceeds the threshold Th₆. As the time from when the carbon dioxide concentration indicated by the operation condition data exceeds the alarm concentration until the proper use is started is shorter, the evaluation value calculating unit 16 may set a higher value as the weight value wd_{k,2} of the air cleaner. When the threshold Th₆ is, for example, 30 minutes, if a staff member or the like of the facility performs an operation to start proper use of the air cleaner within, for example, 15 minutes after the carbon dioxide concentration indicated by the operation condition data of the air cleaner exceeds the alarm concentration, 1.2 is set as the weight value wd_{k,2} of the air cleaner. When a staff member or the like of the facility performs an operation to start proper use of the air cleaner within, for example, 15 minutes or more and 30 minutes or less after the carbon dioxide concentration indicated by the operation condition data of the air cleaner exceeds the alarm concentration, 1.0 is set as the weight value wd_{k,2} of the air cleaner.

If a staff member or the like of the facility does not perform the operation to start the proper use of the air cleaner even when the time period in which the carbon dioxide concentration indicated by the operation condition data of the air cleaner exceeds the alarm concentration exceeds the threshold Th₆, the evaluation value calculating unit 16 sets, for example, a value less than 0.5 as the weight value wd_{k,2} of the air cleaner.

When setting the weight value wd_{k,a} corresponding to the operation condition data of the IoT device 2-n, the evaluation value calculating unit 16 calculates the sum SCₖ of the scores SC₁ to SC₁₄ using the weight value wd_{k,n} as expressed in the following Formula (14), Formula (15), Formula (16), or Formula (17).

SCₖ=SC_{k,1}×wd_{k,1}+SC_{k,2}×wd_{k,2}+SC_{k,3}×wd_{k,3}+ . . . +SC_{k,14}×wd_{k,14} (14)

SCₖ=SC_{k,1}wa_{k,1}×wd_{k,1}+SC_{k,2}×wa_{k,2}×wd_{k,2}+SC_{k,3}×wa_{k,3}×wd_{k,3}+ . . . +SC_{k,14}×wa_{k,14}×wd_{k,14} (15)

SCₖ=SC_{k,1}×wa_{k,1}×wb_{k,1}×wd_{k,1}+SC_{k,2}×wa_{k,2}×wb_{k,2}×wd_{k,2}+SC_{k,3}×wa_{k,3}×wb_{k,3}×wd_{k,3}+ . . . +SC_{k,14}×wa_{k,14}×wb_{k,14}×wd_{k,14} (16)

SCₖ=SC_{k,1}×wa_{k,1}×wb_{k,1}×wc_{k,1}×wd_{k,1}+SC_{k,2}×wa_{k,2}×wb_{k,2}×wc_{k,2}×wd_{k,2}+SC_{k,3}×wa_{k,3}×wb_{k,3}×wc_{k,3}×wd_{k,3}+ . . . +SC_{k,14}×wa_{k,14}×wb_{k,14}×wc_{k,14}×wd_{k,14} (17)

When calculating the sum SCₖ of the scores SC_{k,1} to SC_{k,14} for the facility apparatuses 1-1 to 1-K, the evaluation value calculating unit 16 calculates a deviation value Tₖ of each sum SCₖ as shown in Formula (2).

After calculating the deviation value Tₖ of each of the sums SCₖ, the evaluation value calculating unit 16 outputs the deviation value Tₖ of each of the sums SCₖ to the insurance premium calculating unit 17 as an evaluation value Eₖ indicating the evaluation of each facility as expressed in Formula (3).

(6) Calculation Example of Evaluation Value (6)

In the calculation example (6) of the evaluation value, the calculation processing of the evaluation value is performed using sensor information indicating the type of the sensor 3-m included in the facility apparatus 1-k, that is, the sensor 3-m installed in each facility or the sensor 3-m attached to the user staying in each facility.

The evaluation value calculating unit 16 acquires the sensor information indicating the type of the sensor 3-m included in the facility apparatus 1-k from the sensor information acquiring unit 14.

The evaluation value calculating unit 16 sets a score SC′_{k,m} corresponding to the importance level of the sensor 3-m included in the facility apparatus 1-k on the basis of the type of the sensor 3-m indicated by the sensor information. The score SC′_{k,m} is set to a larger value as the importance level of the sensor 3-m is higher. The importance level of the sensor 3-m is set in advance, and is stored in the internal memory of the evaluation value calculating unit 16, for example.

In the facility evaluation system illustrated in FIG. 1, it is assumed that the sensor 3-m that may be included in the facility apparatus 1-k is, for example, a human sensor, a smoke sensor, a temperature sensor, a carbon dioxide sensor, a bed sensor, a blood pressure sensor, a body temperature sensor, or a heart rate sensor. However, this is merely an example, and the sensor 3-m that may be included in the facility apparatus 1-k may be a sensor different from the above-described eight types of sensors.

Similarly to the calculation example of evaluation value (1), the evaluation value calculating unit 16 sets the score SC_{k,n} corresponding to the importance level of the IoT device 2-n included in the facility apparatus 1-k on the basis of the type of the IoT device 2-n indicated by the installed device information.

In addition, the evaluation value calculating unit 16 sets the score SC′_{k,m} corresponding to the importance level of the sensor 3-m included in the facility apparatus 1-k on the basis of the type of the sensor 3-m indicated by the sensor information. The score SC′_{k,m} is set to a larger value as the importance level of the sensor 3-m is higher. For example, among the eight types of sensors 3-m described above, the human sensor is considered to have the highest importance level, and the smoke sensor, the temperature sensor, the carbon dioxide sensor, the blood pressure sensor, the body temperature sensor, the heart rate sensor, and the bed sensor are considered to have the second highest and subsequent importance levels in this order.

The evaluation value calculating unit 16 calculates a sum SCₖ of the scores SC₁ to SC₁₄ and the scores SC′_{k,1} to SC′_{k,4} as expressed in the following Formula (18).

SCₖ=SC_{k,1}+SC_{k,2}+SC_{k,3}+ . . . +SC_{k,14}+SC′_{k,1}+SC′_{k,2}+SC′_{k,3}+ . . . +SC′_{k,8} (18)

In Formula (18), SC′_{k,1} is a score in a case where the facility apparatus 1-k includes a human sensor, and if the facility apparatus 1-k does not include a human sensor, SC′_{k,1} is “0”.

SC′_{k,2} is a score in a case where the facility apparatus 1-k includes a smoke sensor, and if the facility apparatus 1-k does not include a smoke sensor, SC′_{k,2} is “0”.

SC′_{k,3} is a score in a case where the facility apparatus 1-k includes a temperature sensor, and if the facility apparatus 1-k does not include a temperature sensor, SC′_{k,3} is “0”.

SC′_{k,4} is a score in a case where the facility apparatus 1-k includes a carbon dioxide sensor, and if the facility apparatus 1-k does not include a carbon dioxide sensor, SC′_{k,4} is “0”.

SC′_{k,5} is a score in a case where the facility apparatus 1-k includes a bed sensor, and if the facility apparatus 1-k does not include a bed sensor, SC′_{k,5} is “0”.

SC′_{k,6} is a score in a case where the facility apparatus 1-k includes a blood pressure sensor, and if the facility apparatus 1-k does not include a blood pressure sensor, SC′_{k,6} is “0”.

SC′_{k,7} is a score in a case where the facility apparatus 1-k includes a body temperature sensor, and if the facility apparatus 1-k does not include a body temperature sensor, SC′_{k,7} is “0”.

SC′_{k,8} is a score in a case where the facility apparatus 1-k includes a heart rate sensor, and if the facility apparatus 1-k does not include a heart rate sensor, SC′_{k,8} is “0”.

As described above, the score SC′_{k,m} is set to a larger value as the importance level of the sensor 3-m is higher. However, if the facility apparatus 1-k includes all of the above-described eight types of sensors 3-m, each of the value of the score SC_{k,n} and the value of the score SC′_{k,m} is adjusted so that the sum SCₖ is, for example, 100 points.

When calculating the sum SCₖ of the scores SC_{k,1} to SC_{k,14} and the scores SC′_{k,1} to SC′_{k,8} for the facility apparatuses 1-1 to 1-K, the evaluation value calculating unit 16 calculates a deviation value Tₖ of each sum SCₖ as shown in Formula (2).

When the deviation value Tₖ of each sum SCₖ is calculated, the score SC_{k,n} may be corrected using the weight value similarly to any of the calculation examples (2) to (5) of the evaluation value.

After calculating the deviation value Tₖ of each of the sums SCₖ, the evaluation value calculating unit 16 outputs the deviation value Tₖ of each of the sums SCₖ to the insurance premium calculating unit 17 as an evaluation value Eₖ indicating the evaluation of each facility as expressed in Formula (3).

(7) Calculation Example of Evaluation Value (7)

In the calculation example (7) of the evaluation value, the score SC′_{k,m} is corrected using the weight value we_{k,m} corresponding to the sensing data of the sensor 3-m, so that the calculation processing of the evaluation value Eₖ is performed with higher accuracy than in the calculation example (6).

The evaluation value calculating unit 16 acquires sensing data of the sensor 3-m (m=1, . . . , M) included in the facility apparatus 1-k from the sensing data acquiring unit 15.

Here, an example in which the sensor 3-m is a blood pressure sensor and weight value we_{k,6} of the blood pressure sensor is set, and an example in which the sensor 3-m is a heart rate sensor and weight value we_{k,8} of the heart rate sensor is set will be described.

In a case where the sensor 3-m is a blood pressure sensor, the sensing data of the blood pressure sensor may indicate that the blood pressure of a user is extremely high. The extremely high blood pressure differs for each user, but for example, a blood pressure exceeding 200 [mmHg] can be considered as such a blood pressure.

If the sensing data of the blood pressure sensor indicates a state in which the blood pressure is extremely high and the state continues for a long time, the user's life or death may be involved. When the sensing data of the blood pressure sensor indicates that the blood pressure is extremely high, if a staff member or the like of the facility notices that the blood pressure of the user is extremely high and cares for the user, it can be considered that the support to users is excellent and the facility is good. If a staff member or the like of the facility does not notice that the blood pressure of a user is extremely high and does not care for the user, it can be considered that the support to users is poor and the facility is not good.

The support to users by the staff members or the like of the facility can be grasped from, for example, the operation condition data of the digital camera that is the IoT device 2-n or the operation condition data of the video camera that is the IoT device 2-n. In addition, it can be grasped from nursing care record data indicating nursing care content for users to be described later.

The evaluation value calculating unit 16 sets, for example, a value of 1.0 or more as the weight value we_{k,6} of the blood pressure sensor if there is support for a user by a staff member or the like of the facility within a certain period of time after the sensing data of the blood pressure sensor indicates that the blood pressure is extremely high. The certain period of time may be 3 minutes, 5 minutes, or the like.

If there is no support for the user by the staff member or the like of the facility within a certain period of time after the sensing data of the blood pressure sensor indicates that the blood pressure is extremely high, the evaluation value calculating unit 16 sets, for example, a value less than 0.5 as the weight value we_{k,6} of the blood pressure sensor.

In a case where the sensor 3-m is a heart rate sensor, sensing data of the heart rate sensor may indicate that a user has an arrhythmia.

If the arrhythmia continues for a long time, the user's life or death may be involved. When the sensing data of the heart rate sensor indicates the arrhythmia, if a staff member or the like of the facility notices that the arrhythmia occurs in the user and cares for the user, it can be considered that the support to users is excellent and the facility is good. If a staff member or the like of the facility does not notice that the arrhythmia occurs in the user and does not care for the user, it can be considered that the support for users is poor and the facility is not good.

The support to the user by a staff member or the like of the facility can be grasped from, for example, the operation condition data of the digital camera that is the IoT device 2-n or the operation condition data of the video camera that is the IoT device 2-n. In addition, it can be grasped from nursing care record data indicating nursing care content for the user to be described later.

The evaluation value calculating unit 16 sets, for example, a value of 1.0 or more as the weight value we_{k,8} of the heart rate sensor if there is support for a user by a staff member or the like of the facility within a certain period of time after the sensing data of the heart rate sensor indicates that the arrhythmia occurs in the user. The certain period of time may be 3 minutes, 5 minutes, or the like.

If there is no support for the user by a staff member or the like of the facility within a certain period of time after the sensing data of the heart rate sensor indicates that the arrhythmia occurs in the user, the evaluation value calculating unit 16 sets, for example, a value less than 0.5 as the weight value we_{k,8} of the heart rate sensor.

When setting the weight value we_{k,m} corresponding to the sensing data of the eight types of sensors 3-m, the evaluation value calculating unit 16 calculates the sum SCₖ of the scores SC_{k,1} to SC_{k,14} and the scores SC′_{k,1} to SC′_{k,8} by using the weight value we_{k,m} as shown in the following Formula (19).

SCₖ=SC_{k,1}+SC_{k,2}+SC_{k,3}+ . . . +SC_{k,14}+SC′_{k,1}33 we_{k,1}+SC′_{k,2}×we_{k,2}+SC′_{k,3}×we_{k,3}+ . . . +SC′_{k,8}×we_{k,8} (19)

When calculating the sum SCₖ, the evaluation value calculating unit 16 may correct the score SC_{k,n} using the weight value, similarly to any of the calculation examples (2) to (5) of the evaluation value.

When calculating the sum SCₖ of the scores SC_{k,1} to SC_{k,14} and the scores SC′_{k,1} to SC′_{k,8} for the facility apparatuses 1-1 to 1-K, the evaluation value calculating unit 16 calculates a deviation value Tₖ of each sum SCₖ as shown in Formula (2).

After calculating the deviation value Tₖ of each of the sums SCₖ, the evaluation value calculating unit 16 outputs the deviation value Tₖ of each of the sums SCₖ to the insurance premium calculating unit 17 as an evaluation value Eₖ indicating the evaluation of each facility as expressed in Formula (3).

The insurance premium calculating unit 17 acquires the evaluation value Eₖ of each facility from the evaluation value calculating unit 16.

The insurance premium calculating unit 17 calculates the insurance premium for the corporate insurance for each facility on the basis of the evaluation value Eₖ of each facility (step ST8 in FIG. 5).

Hereinafter, a calculation example of the insurance premium by the insurance premium calculating unit 17 will be described.

(1) Calculation Example of Insurance Premium (1)

The evaluation value Eₖ represents a deviation value of each facility. Therefore, for example, the insurance premium calculating unit 17 sets the insurance premium to X yen when the deviation value of the facility is 60 or more, sets the insurance premium to (X×1.2) yen when the deviation value of the facility is 55 or more and less than 60, and sets the insurance premium to (X×1.4) yen when the deviation value of the facility is 50 or more and less than 55.

In addition, for example, the insurance premium calculating unit 17 sets the insurance premium to (X×1.6) yen when the deviation value of the facility is 45 or more and less than 50, and sets the insurance premium to (X×1.8) yen when the deviation value of the facility is less than 45.

(2) Calculation Example of Insurance Premium (2)

In a case where the insurance premium for the corporate insurance is updated, for example, in units of years, if the insurance premium for the previous year for each facility has determined, the insurance premium calculating unit 17 compares the evaluation value Eₖ of the facility in the current year with the evaluation value Eₖ of the facility in the previous year.

If the difference between the evaluation value Eₖ of the facility in the current year and the evaluation value Eₖ of the facility in the previous year is, for example, less than 3, the insurance premium calculating unit 17 sets the insurance premium for the current year to the same amount as the insurance premium in the previous year.

If the evaluation value Eₖ of the facility in the current year is higher than the evaluation value Eₖ of the facility in the previous year by, for example, 3 or more, the insurance premium calculating unit 17 makes the insurance premium for the current year several percent discount from the insurance premium in the previous year.

If the evaluation value Eₖ of the facility in the current year is lower than the evaluation value Eₖ of the facility in the previous year by, for example, 3 or more, the insurance premium calculating unit 17 sets the insurance premium for the current year to be several percent higher than the insurance premium in the previous year. Here, if the evaluation value Eₖ of the facility in the current year is lower than the evaluation value Eₖ of the facility in the previous year by, for example, 3 or more, the insurance premium calculating unit 17 sets the insurance premium for the current year to be several percent higher than the insurance premium in the previous year. However, this is merely an example, and even if the evaluation value Eₖ of the facility in the current year is lower than the evaluation value Eₖ of the facility in the previous year by, for example, 3 or more, the insurance premium calculating unit 17 may set the insurance premium for the current year to be several percent higher than the insurance premium in the previous year only in a case where the insurance is used due to the occurrence of an accident, an injury, or the like.

The insurance premium calculated by the insurance premium calculating unit 17 is presented to the insurance company.

Although not illustrated in FIG. 1 illustrating the facility evaluation system, in a case where a computer or the like of an insurance company is connected to the network 5, the insurance premium calculating unit 17 may transmit data indicating the insurance premium calculated by the insurance premium calculating unit 17 to the computer or the like of the insurance company via the network 5.

Note that the evaluation value Eₖ calculated by the evaluation value calculating unit 16, the installed device information, the log data, the operation condition data, the sensor information, and the sensing data may be transmitted from the facility evaluation apparatus 6 to a computer or the like of an insurance company, a computer or the like of a pharmaceutical company, or the like.

In the first embodiment described above, the facility evaluation apparatus 6 is configured to include the device information acquiring unit 11 that acquires the installed device information indicating the type of the IoT device 2-n installed in the facility to be evaluated, and the evaluation value calculating unit 16 that calculates the evaluation value indicating the value of the facility on the basis of the installed device information acquired by the device information acquiring unit 11. Therefore, the facility evaluation apparatus 6 can objectively evaluate the value of the facility.

In the facility evaluation apparatus 6 illustrated in FIG. 2, the evaluation value calculating unit 16 calculates the evaluation value Eₖ of the facility by, for example, performing calculation based on Formulas (1) and (2). However, this is merely an example, and for example, the evaluation value calculating unit 16 may include a machine learning device that outputs the evaluation value Eₖ of the facility when log data, operation condition data, sensor information, or sensing data is given in addition to the installed device information, and may output the evaluation value Eₖ output from the machine learning device to the insurance premium calculating unit 17.

The machine learning device is a device equipped with artificial intelligence (AI), and learns, for example, a relationship between installed device information, log data, operation condition data, sensor information, or sensing data, and the evaluation value Eₖ. As described above, when log data, operation condition data, sensor information, or sensing data is given in addition to the installed device information, the learned machine learning device outputs the evaluation value Eₖ of the facility.

Second Embodiment

In a second embodiment, a facility evaluation apparatus 6 including a nursing care record data acquiring unit 18 that acquires nursing care record data indicating nursing care content for a user will be described.

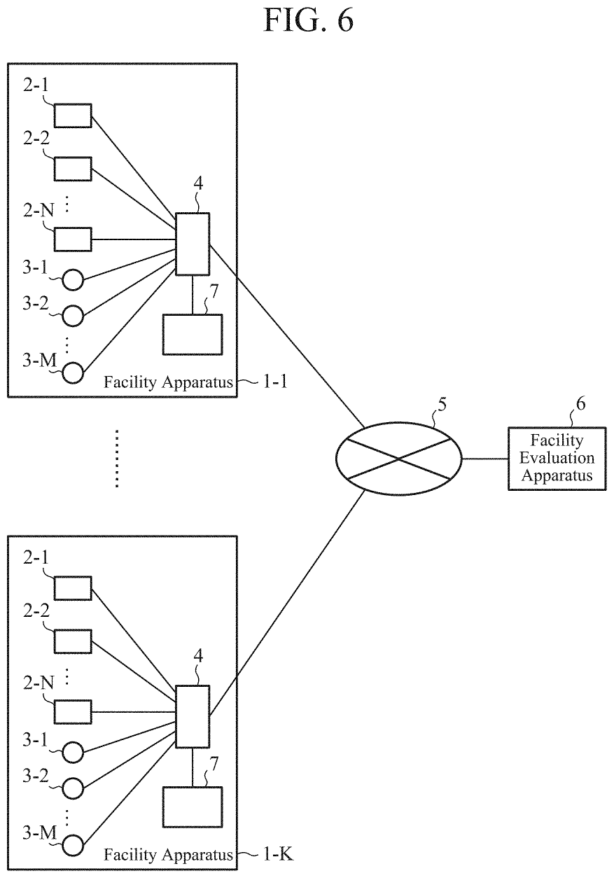

FIG. 6 is a configuration diagram illustrating a facility evaluation system including the facility evaluation apparatus 6 according to the second embodiment. In FIG. 6, the same reference numerals as those in FIG. 1 denote the same or corresponding parts, and thus description thereof is omitted.

A nursing care recording device 7 is implemented by a personal computer, a tablet terminal, or the like.

The nursing care recording device 7 stores nursing care record data indicating nursing care content for users.

The nursing care recording device 7 outputs the nursing care record data to the facility evaluation apparatus 6 via the line concentrator 4 and the network 5.

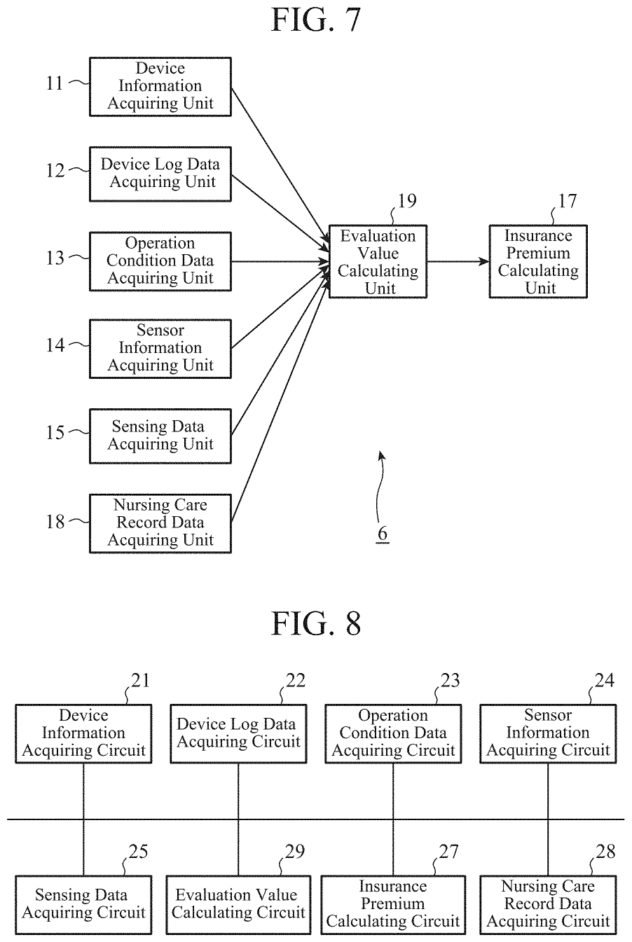

FIG. 7 is a configuration diagram illustrating the facility evaluation apparatus 6 according to the second embodiment.

FIG. 8 is a hardware configuration diagram illustrating hardware of the facility evaluation apparatus 6 according to the second embodiment.

In FIGS. 7 and 8, the same reference numerals as those in FIGS. 1 and 2 denote the same or corresponding parts, and thus description thereof is omitted.

The facility evaluation apparatus 6 illustrated in FIG. 7 includes a device information acquiring unit 11, a device log data acquiring unit 12, an operation condition data acquiring unit 13, a sensor information acquiring unit 14, a sensing data acquiring unit 15, the nursing care record data acquiring unit 18, an evaluation value calculating unit 19, and an insurance premium calculating unit 17.

The nursing care record data acquiring unit 18 is implemented by, for example, a nursing care record data acquiring circuit 28 illustrated in FIG. 8.

The nursing care record data acquiring unit 18 acquires nursing care record data saved in the nursing care recording device 7 from the facility apparatus 1-k (k=1, . . . , K).

The nursing care record data acquiring unit 18 outputs the nursing care record data to the evaluation value calculating unit 19.

The evaluation value calculating unit 19 is implemented by, for example, an evaluation value calculating circuit 29 illustrated in FIG. 8.

The evaluation value calculating unit 19 acquires the installed device information from the device information acquiring unit 11, acquires the log data from the device log data acquiring unit 12, and acquires the operation condition data from the operation condition data acquiring unit 13.

Further, the evaluation value calculating unit 19 acquires the sensor information from the sensor information acquiring unit 14, acquires the sensing data from the sensing data acquiring unit 15, and acquires the nursing care record data from the nursing care record data acquiring unit 18.

The evaluation value calculating unit 19 calculates an evaluation value indicating the value of each facility on the basis of at least the installed device information.

The evaluation value calculating unit 19 may calculate the evaluation value on the basis of log data, operation condition data, sensor information, sensing data, or nursing care record data in addition to the installed device information.

The evaluation value calculating unit 19 outputs the evaluation value to the insurance premium calculating unit 17.

In FIG. 7, it is assumed that each of the device information acquiring unit 11, the device log data acquiring unit 12, the operation condition data acquiring unit 13, the sensor information acquiring unit 14, the sensing data acquiring unit 15, the nursing care record data acquiring unit 18, the evaluation value calculating unit 19, and the insurance premium calculating unit 17, which are components of the facility evaluation apparatus 6, is implemented by dedicated hardware as illustrated in FIG. 8. That is, it is assumed that the facility evaluation apparatus 6 is implemented by a device information acquiring circuit 21, a device log data acquiring circuit 22, an operation condition data acquiring circuit 23, a sensor information acquiring circuit 24, a sensing data acquiring circuit 25, a nursing care record data acquiring circuit 28, an evaluation value calculating circuit 29, and an insurance premium calculating circuit 27.

Each of the device information acquiring circuit 21, the device log data acquiring circuit 22, the operation condition data acquiring circuit 23, the sensor information acquiring circuit 24, the sensing data acquiring circuit 25, the nursing care record data acquiring circuit 28, the evaluation value calculating circuit 29, and the insurance premium calculating circuit 27 corresponds to, for example, a single circuit, a composite circuit, a programmed processor, a parallel-programmed processor, ASIC, FPGA, or a combination thereof.

The components of the facility evaluation apparatus 6 are not limited to those implemented by dedicated hardware, and the facility evaluation apparatus 6 may be implemented by software, firmware, or a combination of software and firmware.

In a case where the facility evaluation apparatus 6 is implemented by software, firmware, or the like, a program for causing a computer to execute each processing procedure performed in the device information acquiring unit 11, the device log data acquiring unit 12, the operation condition data acquiring unit 13, the sensor information acquiring unit 14, the sensing data acquiring unit 15, the nursing care record data acquiring unit 18, the evaluation value calculating unit 19, and the insurance premium calculating unit 17 is stored in the memory 31 illustrated in FIG. 4. Then, the processor 32 illustrated in FIG. 4 executes the program stored in the memory 31.

In addition, FIG. 8 illustrates an example in which each of the components of the facility evaluation apparatus 6 is implemented by dedicated hardware, and FIG. 4 illustrates an example in which the facility evaluation apparatus 6 is implemented by software, firmware, or the like. However, this is merely an example, and some components in the facility evaluation apparatus 6 may be implemented by dedicated hardware, and the remaining components may be implemented by software, firmware, or the like.

Next, the operation of the facility evaluation system illustrated in FIG. 6 will be described.

However, since the facility evaluation system is similar to the facility evaluation system illustrated in FIG. 1 except for the nursing care recording device 7, the nursing care record data acquiring unit 18, and the evaluation value calculating unit 19, only the operations of the nursing care recording device 7, the nursing care record data acquiring unit 18, and the evaluation value calculating unit 19 will be described here.

For example, the nursing care recording device 7 receives a record of the nursing care content for the user by a staff member or the like of the facility, and stores nursing care record data indicating the nursing care content in an internal memory or an external memory.

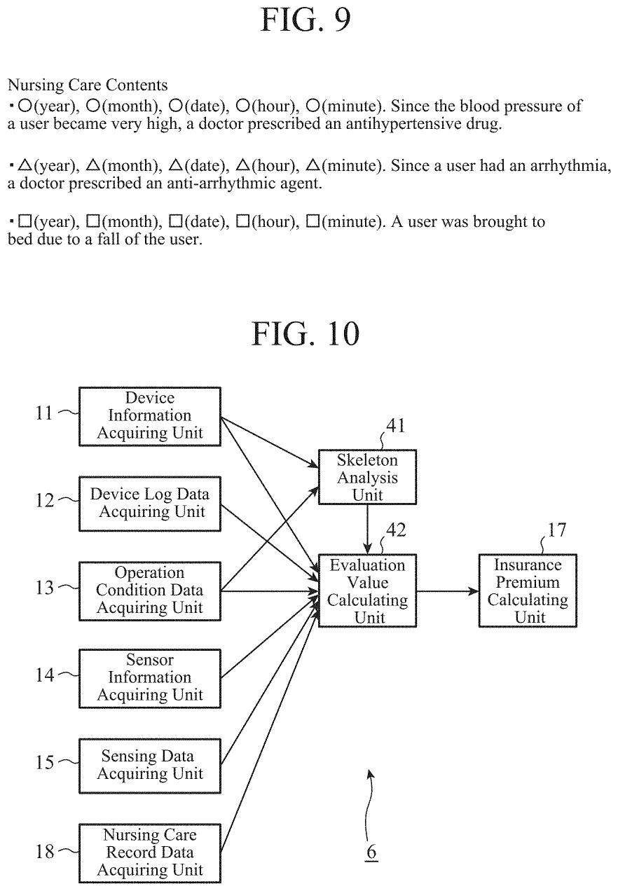

FIG. 9 is an explanatory diagram illustrating an example of nursing care content.

FIG. 9 illustrates an example of nursing care content of “Δ(year), Δ(month), Δ(date), Δ(hour), Δ(minute). Since a user had an arrhythmia, a doctor prescribed an anti-arrhythmic agent.” in addition to nursing care content of “Δ(year), Δ(month), Δ(date), Δ(hour), Δ(minute). Since the blood pressure of a user became very high, a doctor prescribed an antihypertensive drug.”.

Furthermore, FIG. 9 illustrates an example of nursing care content of “□(year), □(month), □(date), □(hour), □(minute). The user was brought to bed due to a fall of the user.”.

The nursing care recording device 7 outputs the nursing care record data stored in the internal memory or the like to the facility evaluation apparatus 6 via the line concentrator 4 and the network 5 at regular time intervals or when receiving a transmission request of the nursing care record data from the facility evaluation apparatus 6.

The nursing care record data acquiring unit 18 acquires the nursing care record data saved in the nursing care recording device 7 from the facility apparatus 1-k (k=1, . . . , K).

The nursing care record data acquiring unit 18 outputs the nursing care record data to the evaluation value calculating unit 19.

The evaluation value calculating unit 19 acquires the installed device information from the device information acquiring unit 11, acquires the log data from the device log data acquiring unit 12, and acquires the operation condition data from the operation condition data acquiring unit 13.

Further, the evaluation value calculating unit 19 acquires the sensor information from the sensor information acquiring unit 14, acquires the sensing data from the sensing data acquiring unit 15, and acquires the nursing care record data from the nursing care record data acquiring unit 18.

The evaluation value calculating unit 19 calculates an evaluation value Eₖ indicating the value of each facility on the basis of at least the installed device information.

Hereinafter, an example in which the evaluation value calculating unit 19 calculates the evaluation value Eₖ indicating the value of each facility on the basis of the nursing care record data will be described.

The evaluation value calculating unit 19 calculates a score SC″ₖ corresponding to the nursing care record data.

If the nursing care record data as illustrated in FIG. 9, that is, the nursing care record data indicating the nursing care content indicating that care has been performed for the user is saved in the nursing care recording device 7, it can be considered that the staff member or the like of the facility has cared for the user, and the facility is good.

For example, if the nursing care record data indicates nursing care content of “◯(year), ◯(month), ◯(date), ◯(hour), ◯(minute). Since the blood pressure of the user became very high, the doctor prescribed an antihypertensive drug.”, it can be considered that the staff member or the like of the facility has cared for the user, and the facility is good.

In addition, if the nursing care record data indicates nursing care content of “□(year), □(month), □(date), □(hour), □(minute). A user was brought to bed due to a fall of the user.”, it can be considered that a staff member or the like of the facility has cared for the user, and the facility is good.

If the nursing care record data indicating the nursing care content indicating that care has been performed for the user is saved in the nursing care recording device 7, it can be considered that the facility is good, and thus a positive value is set to a score SC″ₖ as an addition element with respect to the sum SCₖ as illustrated in the following Formula (20). The positive value is not particularly limited, but for example, a value equal to or less than the value of the score SC_{k,n} can be considered as such a value.

SCₖ=SC_{k,1}+SC_{k,2}+SC_{k,3}+ . . . +SC_{k,14}+SC′_{k,1}+SC′_{k,2}+SC′_{k,3}+ . . . +SC′_{k,8}+SC″ₖ (20)

If the nursing care record data indicating the nursing care content indicating that a staff member or the like of the facility cares for a user is not saved in the nursing care recording device 7, the value of the score SC″ₖ is “0”.

The evaluation value calculating unit 19 needs to analyze whether or not the nursing care record data indicates the nursing care content indicating that care has been performed for the user. Such analysis processing itself is a known technique, and thus detailed description thereof will be omitted.

When calculating the sum SCₖ, the evaluation value calculating unit 19 may correct at least one of the score SC_{k,n} or the score SC′_{k,m} using the weight value, similarly to any of the calculation examples (2) to (5) and (7) of the evaluation value.

When calculating the sum SCₖ of the scores SC_{k,1} to SC_{k,14}, the scores SC′_{k,1} to SC′_{k,8}, and the score SC″ₖ for the facility apparatuses 1-1 to 1-K, the evaluation value calculating unit 19 calculates a deviation value Tₖ of each sum SCₖ as shown in Formula (2).

After calculating the deviation value Tₖ of each of the sums SCₖ, the evaluation value calculating unit 19 outputs the deviation value Tₖ of each sum SCₖ to the insurance premium calculating unit 17 as an evaluation value Eₖ indicating the evaluation of each facility as expressed in Formula (3).

In the above-described second embodiment, the facility evaluation apparatus 6 illustrated in FIG. 7 is configured to include the nursing care record data acquiring unit 18 that acquires nursing care record data indicating the nursing care content for the user, in which the evaluation value calculating unit 19 calculates the evaluation value indicating the value of the facility on the basis of the installed device information acquired by the device information acquiring unit 11 and the nursing care record data acquired by the nursing care record data acquiring unit 18. Therefore, the facility evaluation apparatus 6 illustrated in FIG. 7 can enhance the objectivity of the evaluation value more than the facility evaluation apparatus 6 illustrated in FIG. 2.

In the facility evaluation apparatus 6 illustrated in FIG. 7, when the nursing care record data indicating the nursing care content indicating that care has been performed for the user is saved in the nursing care recording device 7, the evaluation value calculating unit 19 sets a positive value to the score SC″ₖ as an addition element to the sum SCₖ. However, this is merely an example, and if the record interval of the nursing care record data saved in the nursing care recording device 7 is less than a threshold Th₇, the evaluation value calculating unit 19 determines that the care of the user is good, and sets a positive value to the score SC″ₖ as an addition element to the sum SCₖ. On the other hand, if the recording interval of the nursing care record data is the threshold Th₇ or more, the evaluation value calculating unit 19 may determine that the care of the user is not very good, and set a negative value to the score SC″ₖ as an addition element to the sum SCₖ.

The threshold Th₇ may be stored in the internal memory of the evaluation value calculating unit 19 or may be given from the outside of the facility evaluation apparatus 6.

In addition, if the number of records of the nursing care record data within a certain period of time stored in the nursing care recording device 7 is equal to or larger than a threshold Th₈, the evaluation value calculating unit 19 determines that the care of the user is good, and sets a positive value to the score SC″ₖ as an addition element to the sum SCₖ. On the other hand, if the number of records of the nursing care record data within a certain period of time is less than the threshold Th₈, the evaluation value calculating unit 19 may determine that the care for the user is not very good, and set a negative value to the score SC″ₖ as an addition element to the sum SCₖ.

The threshold Th₈ may be stored in the internal memory of the evaluation value calculating unit 19 or may be given from the outside of the facility evaluation apparatus 6.

In addition, if the average number of characters in the nursing care content indicated by the nursing care record data stored in the nursing care recording device 7 is equal to or more than a threshold Th₉, the evaluation value calculating unit 19 determines that the care of the user is good, and sets a positive value to the score SC″ₖ as an addition element to the sum SCₖ. On the other hand, if the average number of characters is less than the threshold Th₉, the evaluation value calculating unit 19 may determine that the care for the user is not very good, and set a negative value to the score SC″ₖ as an addition element to the sum SCₖ.

The threshold Th₉ may be stored in the internal memory of the evaluation value calculating unit 19 or may be given from the outside of the facility evaluation apparatus 6.

Third Embodiment

In a third embodiment, a facility evaluation apparatus 6 including a skeleton analysis unit 41 that analyzes the skeleton of a user staying in a facility from an image captured by a camera will be described.

FIG. 10 is a configuration diagram illustrating the facility evaluation apparatus 6 according to the third embodiment.

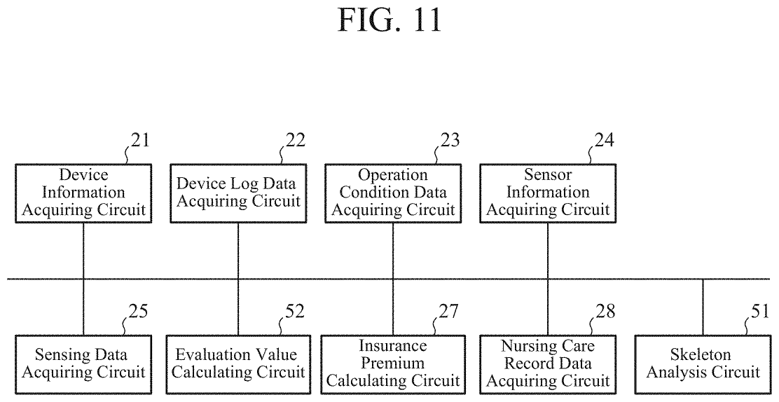

FIG. 11 is a hardware configuration diagram illustrating hardware of the facility evaluation apparatus 6 according to the third embodiment.

In FIGS. 10 and 11, the same reference numerals as those in FIGS. 1, 2, 7, and 8 denote the same or corresponding parts, and thus description thereof is omitted.

The facility evaluation apparatus 6 illustrated in FIG. 10 includes a device information acquiring unit 11, a device log data acquiring unit 12, an operation condition data acquiring unit 13, a sensor information acquiring unit 14, a sensing data acquiring unit 15, a nursing care record data acquiring unit 18, the skeleton analysis unit 41, an evaluation value calculating unit 42, and an insurance premium calculating unit 17.

Note that, in the facility evaluation apparatus 6 illustrated in FIG. 10, an example is illustrated in which the skeleton analysis unit 41 and the evaluation value calculating unit 42 are applied to the facility evaluation apparatus 6 illustrated in FIG. 7. However, this is merely an example, and the skeleton analysis unit 41 and the evaluation value calculating unit 42 may be applied to the facility evaluation apparatus 6 illustrated in FIG. 2.

In the third embodiment, one IoT device 2-n among the IoT devices 2-1 to 2-N is a camera.

The skeleton analysis unit 41 is implemented by, for example, a skeleton analysis circuit 51 illustrated in FIG. 11.

The skeleton analysis unit 41 acquires the installed device information from the device information acquiring unit 11, and specifies which IoT device 2-n among the IoT devices 2-1 to 2-N is a camera on the basis of the installed device information.

The skeleton analysis unit 41 acquires the operation condition data output from the IoT device 2-n specified as a camera among the operation condition data output from the operation condition data acquiring unit 13. The operation condition data is data indicating an image captured by the camera.

The skeleton analysis unit 41 analyzes the skeleton of a user staying in the facility from the image captured by the camera, and outputs skeleton data indicating the analysis result of the skeleton to the evaluation value calculating unit 42.

The evaluation value calculating unit 42 is implemented by, for example, an evaluation value calculating circuit 52 illustrated in FIG. 8.

The evaluation value calculating unit 42 acquires installed device information from the device information acquiring unit 11, acquires the log data from the device log data acquiring unit 12, and acquires the operation condition data from the operation condition data acquiring unit 13.

In addition, the evaluation value calculating unit 42 acquires the sensor information from the sensor information acquiring unit 14, acquires the sensing data from the sensing data acquiring unit 15, acquires the nursing care record data from the nursing care record data acquiring unit 18, and acquires the skeleton data from the skeleton analysis unit 41.

The evaluation value calculating unit 42 calculates an evaluation value indicating the value of each facility on the basis of the installed device information, the nursing care record data, and the skeleton data.

The evaluation value calculating unit 42 may calculate the evaluation value on the basis of the log data, the operation condition data, sensor information, or the sensing data in addition to the installed device information, the nursing care record data, and the skeleton data.

The evaluation value calculating unit 42 outputs the evaluation value to the insurance premium calculating unit 17.

In FIG. 10, it is assumed that each of the device information acquiring unit 11, the device log data acquiring unit 12, the operation condition data acquiring unit 13, the sensor information acquiring unit 14, the sensing data acquiring unit 15, the nursing care record data acquiring unit 18, the skeleton analysis unit 41, the evaluation value calculating unit 42, and the insurance premium calculating unit 17, which are components of the facility evaluation apparatus 6, is implemented by dedicated hardware as illustrated in FIG. 11. That is, it is assumed that the facility evaluation apparatus 6 is implemented by the device information acquiring circuit 21, the device log data acquiring circuit 22, the operation condition data acquiring circuit 23, the sensor information acquiring circuit 24, the sensing data acquiring circuit 25, the nursing care record data acquiring circuit 28, the skeleton analysis circuit 51, the evaluation value calculating circuit 52, and the insurance premium calculating circuit 27.

Each of the device information acquiring circuit 21, the device log data acquiring circuit 22, the operation condition data acquiring circuit 23, the sensor information acquiring circuit 24, the sensing data acquiring circuit 25, the nursing care record data acquiring circuit 28, the skeleton analysis circuit 51, the evaluation value calculating circuit 52, and the insurance premium calculating circuit 27 corresponds to, for example, a single circuit, a composite circuit, a programmed processor, a parallel-programmed processor, ASIC, FPGA, or a combination thereof.

The components of the facility evaluation apparatus 6 are not limited to those implemented by dedicated hardware, and the facility evaluation apparatus 6 may be implemented by software, firmware, or a combination of software and firmware.

In a case where the facility evaluation apparatus 6 is implemented by software, firmware, or the like, a program for causing a computer to execute each processing procedure performed in the device information acquiring unit 11, the device log data acquiring unit 12, the operation condition data acquiring unit 13, the sensor information acquiring unit 14, the sensing data acquiring unit 15, the nursing care record data acquiring unit 18, the skeleton analysis unit 41, the evaluation value calculating unit 42, and the insurance premium calculating unit 17 is stored in the memory 31 illustrated in FIG. 4. Then, the processor 32 illustrated in FIG. 4 executes the program stored in the memory 31.

In addition, FIG. 11 illustrates an example in which each of the components of the facility evaluation apparatus 6 is implemented by dedicated hardware, and FIG. 4 illustrates an example in which the facility evaluation apparatus 6 is implemented by software, firmware, or the like. However, this is merely an example, and some components in the facility evaluation apparatus 6 may be implemented by dedicated hardware, and the remaining components may be implemented by software, firmware, or the like.

Next, the operation of the facility evaluation apparatus 6 illustrated in FIG. 10 will be described.

However, since operations other than those of the skeleton analysis unit 41 and the evaluation value calculating unit 42 are similar to those of the facility evaluation apparatus 6 illustrated in FIG. 7, only the operations of the skeleton analysis unit 41 and the evaluation value calculating unit 42 will be described here.

The skeleton analysis unit 41 acquires the installed device information from the device information acquiring unit 11.

The skeleton analysis unit 41 specifies which IoT device 2-n among the IoT devices 2-1 to 2-N is a camera on the basis of the installed device information.

The skeleton analysis unit 41 acquires the operation condition data output from the IoT device 2-n specified as a camera among the operation condition data output from the operation condition data acquiring unit 13. The operation condition data is data indicating an image captured by the camera.

The skeleton analysis unit 41 analyzes the skeleton of the user from the image captured by the camera. Since the processing of analyzing the skeleton of the user itself is a known technique, detailed description thereof will be omitted.

The skeleton analysis unit 41 outputs skeleton data indicating the analysis result of the skeleton to the evaluation value calculating unit 42.

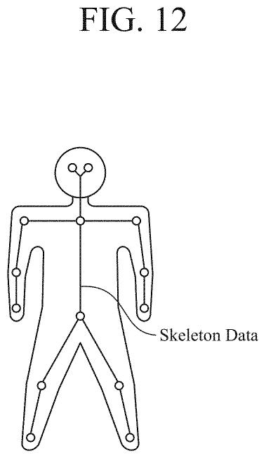

FIG. 12 is an explanatory diagram illustrating an example of skeleton data output from the skeleton analysis unit 41.

The evaluation value calculating unit 42 acquires the installed device information from the device information acquiring unit 11, acquires the log data from the device log data acquiring unit 12, and acquires the operation condition data from the operation condition data acquiring unit 13.

In addition, the evaluation value calculating unit 42 acquires the sensor information from the sensor information acquiring unit 14, acquires the sensing data from the sensing data acquiring unit 15, acquires the nursing care record data from the nursing care record data acquiring unit 18, and acquires the skeleton data from the skeleton analysis unit 41.

The evaluation value calculating unit 42 calculates an evaluation value Eₖ indicating the value of each facility on the basis of the installed device information, the nursing care record data, and the skeleton data.

Hereinafter, an example in which the evaluation value calculating unit 42 calculates the evaluation value Eₖ indicating the value of each facility on the basis of the installed device information, the nursing care record data, and the skeleton data will be specifically described.

The evaluation value calculating unit 42 detects a disordered state of the user on the basis of the skeleton data. As the disordered state of the user, falling of the user, crouching of the user, or the like is considered. The processing of detecting the falling of the user or the processing of detecting the crouching of the user on the basis of the skeleton data is a known technique, and thus a detailed description thereof will be omitted.

The evaluation value calculating unit 42 determines whether or not there is nursing care record data indicating that the staff member or the like of the facility has cared for the user after the time when the disordered state of the user is detected in the nursing care record data output from the nursing care record data acquiring unit 18.

If there is nursing care record data indicating that the staff member or the like of the facility cared for the user after the time when the disordered state of the user was detected, it can be considered that the facility is good.

If there is no nursing care record data indicating that a staff member or the like of the facility cared for the user after the time when the disordered state of the user was detected, there is a high possibility that the staff member or the like of the facility did not care for the user, and it can be considered that the facility is not good.

Note that, even in a case where there is nursing care record data indicating that the staff member or the like of the facility has cared for the user after the time when the disordered state of the user was detected, in a case where the time from the detection of the disordered state to the start of the care for the user is long, it cannot be said that the care for the user is very good, and thus it can be considered that the facility is not good. The long time until the start of care may be 20 minutes, 30 minutes, or the like.

In a case where the facility is considered to be good, the evaluation value calculating unit 42 sets a positive value to the score SC*ₖ as an addition element with respect to the sum SCₖ as expressed in the following Formula (21).

The evaluation value calculating unit 42 sets a negative value to the score SC*ₖ in a case where it can be considered that the facility is not good.

Each of the absolute values of the positive value and the negative value is not particularly limited, but for example, a value equal to or less than the value of the score SC_{k,n} can be considered as such absolute values.

SCₖ=SC_{k,1}+SC_{k,2}+SC_{k,3}+ . . . +SC_{k,14}+SC′_{k,1}+SC′_{k,2}+SC′_{k,3}+ . . . +SC′_{k,8}+SC″ₖ+score SC*ₖ (21)

When calculating the sum SCₖ, the evaluation value calculating unit 42 may correct at least one of the score SC_{k,n} or the score SC′_{k,m} using the weight value, similarly to any of the calculation examples (2) to (5) and (7) of the evaluation value.

When calculating the sum SCₖ of the scores SC_{k,1} to SC_{k,14}, the scores SC′_{k,1} to SC′_{k,8}, the score SC″ₖ, and the score SC*ₖ for the facility apparatuses 1-1 to 1-K, the evaluation value calculating unit 42 calculates a deviation value Tₖ of each sum SCₖ as shown in Formula (2).

After calculating the deviation value Tₖ of each sum SCₖ, the evaluation value calculating unit 42 outputs the deviation value Tₖ of each sum SCₖ to the insurance premium calculating unit 17 as an evaluation value Eₖ indicating the evaluation of each facility as expressed in Formula (3).

In the above-described third embodiment, the facility evaluation apparatus 6 illustrated in FIG. 10 is configured so that a camera is installed as the IoT device 2-n installed in the facility, the skeleton analysis unit 41 that analyzes the skeleton of a user from the image captured by the camera is provided, and the evaluation value calculating unit 42 calculates the evaluation value indicating the value of the facility on the basis of the installed device information acquired by the device information acquiring unit 11, the nursing care record data acquired by the nursing care record data acquiring unit 18, and the analysis result of the skeleton by the skeleton analysis unit 41. Therefore, the facility evaluation apparatus 6 illustrated in FIG. 10 can enhance the objectivity of the evaluation value more than the facility evaluation apparatus 6 illustrated in FIG. 2.

It should be noted that the present disclosure can freely combine the embodiments, modify any component of each of the embodiments, or omit any component in each of the embodiments.

### Industrial Applicability

The present disclosure is suitable for a facility evaluation apparatus and a facility evaluation method.

### REFERENCE SIGNS LIST

1-1 to 1-K: facility apparatus, 2-1 to 2-N: IoT device, 3-1 to 3-M: sensor, 4: line concentrator, 5: network, 6: facility evaluation apparatus, 7: nursing care recording device, 11: device information acquiring unit, 12: device log data acquiring unit, 13: operation condition data acquiring unit, 14: sensor information acquiring unit, 15: sensing data acquiring unit, 16: evaluation value calculating unit, 17: insurance premium calculating unit, 18: nursing care record data acquiring unit, 19: evaluation value calculating unit, 21: device information acquiring circuit, 22: device log data acquiring circuit, 23: operation condition data acquiring circuit, 24: sensor information acquiring circuit, 25: sensing data acquiring circuit, 26: evaluation value calculating circuit, 27: insurance premium calculating circuit, 28: nursing care record data acquiring circuit, 29: evaluation value calculating circuit, 31: memory, 32: processor, 41: skeleton analysis unit, 42: evaluation value calculating unit, 51: skeleton analysis circuit, 52: evaluation value calculating circuit

1. A facility evaluation apparatus comprising processing circuitry
to acquire installed device information indicating a type of an IoT device installed in a facility to be evaluated, and
to set a score corresponding to an importance level of the IoT device on a basis of the type indicated by the installed device information, and calculate an evaluation value indicating a value of the facility.

2. The facility evaluation apparatus according to claim 1, wherein the processing circuitry acquires the installed device information indicating the type of each of a plurality of IoT devices installed in the facility to be evaluated, a number of the plurality of IoT devices being N (N represents an integer equal to or more than 1),
sets the score corresponding to the importance level of each of the plurality of IoT devices on a basis of the type indicated by the installed device information, and calculates a deviation value of a sum of the score corresponding to the importance level of each of the plurality of IoT devices as the evaluation value indicating the value of the facility, and
calculates an insurance premium for a corporation insurance for the facility on a basis of the deviation value.

3. The facility evaluation apparatus according to claim 1, wherein
the processing circuitry acquires the installed device information indicating a function of the IoT device in addition to the type of the IoT device installed in the facility, and
corrects the score corresponding to the importance level of the IoT device using a weight value corresponding to the function of the IoT device.

4. The facility evaluation apparatus according to claim 1, wherein
the processing circuitry acquires the installed device information indicating the type of each of a plurality of IoT devices installed in the facility to be evaluated, a number of the plurality of IoT devices being N (N represents an integer equal to or more than 1), specifies a number of IoT devices of a same type among the plurality of IoT devices installed in the facility on the basis of the installed device information, and
sets a score corresponding to an importance level of each of the plurality of IoT devices on a basis of the type indicated by the installed device information, and corrects the score corresponding to the importance level of each of the plurality of IoT devices using a weight value corresponding to the number of the IoT devices of the same type.

5. The facility evaluation apparatus according to claim 1, wherein the processing circuitry acquires log data indicating an operation history of the IoT device installed in the facility, and
corrects the score corresponding to the importance level of the IoT device using a weight value corresponding to the log data.

6. The facility evaluation apparatus according to claim 1, wherein the processing circuitry acquires operation condition data indicating an operation condition of the IoT device installed in the facility, and
corrects the score corresponding to the importance level of the IoT device using a weight value corresponding to the operation condition data.

7. The facility evaluation apparatus according to claim 1, wherein the processing circuitry acquires sensor information indicating a type of a sensor installed in the facility or sensor information indicating a type of a sensor attached to a user staying in the facility, and
sets a first score corresponding to the importance level of the IoT device and, on a basis of the type indicated by the sensor information, sets a second score corresponding to an importance level of another IoT device installed in the facility, and calculates the evaluation value indicating the value of the facility using the first score and the second score.

8. The facility evaluation apparatus according to claim 7, wherein the processing circuitry acquires sensing data of a sensor installed in the facility or sensing data of a sensor attached to a user staying in the facility, and
corrects the second score using a weight value corresponding to the sensing data.

9. The facility evaluation apparatus according to claim 1, wherein the processing circuitry acquires nursing care record data indicating nursing care content for a user staying in the facility, and
sets a first score corresponding to the importance level of the IoT device, sets a third score corresponding to nursing care record data, and calculates the evaluation value indicating the value of the facility using the first score and the third score.

10. The facility evaluation apparatus according to claim 9, wherein the processing circuitry performs analysis of a skeleton of the user from an image captured by a camera, the camera being installed as the IoT device installed in the facility, and
sets the third score on a basis of a result of the analysis of the skeleton and the nursing care record data.

11. A facility evaluation method comprising:
acquiring installed device information indicating a type of an IoT device installed in a facility to be evaluated; and
setting a score corresponding to an importance level of the IoT device on a basis of the type indicated by the installed device information, and calculating an evaluation value indicating a value of the facility.
